(19) United States
(12) Patent Application Publication
(10) Pub. No.: US 2012/0020232 A1
(43) Pub. Date: Jan. 26, 2012

(54) COMMUNICATION APPARATUS, COMMUNICATION SYSTEM AND COMMUNICATION METHOD

(76) Inventors: DAISUKE YOSHIOKA, Tokyo (JP); Masaki Umayabashi, Tokyo (JP); Kazuo Takagi, Tokyo (JP); Hiroshi Tanaka, Tokyo (JP); Zhenlong Cui, Tokyo (JP)

(21) Appl. No.: 13/182,362

(22) Filed: Jul. 13, 2011

(30) Foreign Application Priority Data
Jul. 21, 2010 (JP) 164197/2010

(51) Int. Cl. H04L 12/26

(52) U.S. Cl. 370/252

(57) ABSTRACT

A communication apparatus including: a counter storage unit storing a reception counter value of the apparatus when a specific frame is received; a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received; a transmission unit transmitting the specific frame; and a frame control unit adding, to the specific frame, loss information associating the number of frame losses occurring between the apparatus and the preceding apparatus with an identifier of the apparatus and forwarding the specific frame to the transmission unit, when the frame loss occurs, and forwarding the specific frame to the transmission unit without adding the loss information to the specific frame, when no frame loss occurs.

This application is based upon and claims the benefit of priority from Japanese Patent Application No. 2010-164197, filed on Jul. 21, 2010, the disclosure of which is incorporated herein in its entirety by reference.

### TECHNICAL FIELD

The invention relates to a communication apparatus, a communication system and a communication method, which measure a loss of data on a communication network.

### BACKGROUND ART

Technical development is proceeding in these days, which relates to Loss Measurement

(LM) of communication data (frame packet) performed on a communication network, like Ethernet (registered trademark), MPLS (Multiprotocol Label Switching) network, MPLS-TP (Multiprotocol Label Switching-Transport Profile) network, and the like.

For example, Non-patent literature 1 describes a method for measuring a frame loss between a pair of terminal apparatuses which is connected to each other through a communication network. The pair of terminal apparatuses is management apparatuses each having the same MEG (Maintenance Entity Group) level which is a management unit of a group to which a communication apparatus belongs. The management apparatus is called MEP (Maintenance Entity Group End Point). By transmitting and receiving an OAM (Operation Administration and Maintenance) frame between the MEPs, management of the network between the MEPs is performed.

The frame loss between the MEPs is measured by using the OAM frame. Functions of the OAM are, for example, CC (Continuity Check), LB (Loop Back), LT (Link Trace), and the like, which are described in Non-Patent literature 1. Particularly, a LM frame related to the frame loss is described below. The LM frame includes a LMM (Loss Measurement Message) frame and a LMR (Loss Measurement Reply) frame which is a reply to the LMM frame. “LM frame” described below includes both of the LMM frame and the LMR frame unless otherwise instructed.

However, the technology disclosed in Non-patent literature 1 includes a problem described below. When a repeater is placed at the same MEG level, and a transmission and reception unit of the repeater functions as MIP (Maintenance Entity Group Intermediate Point), it is not considered to distinguish which side of the repeater the frame loss occurs. Therefore, it is not possible to provide a carrier strictly demanding services with a highly satisfactory communication system.

Patent literature 1 and Patent literature 2 discloses following technology in order to solve the problem above. MIP-ID, which is a MIP-specific identifier, and a counter value are written into the LMM frame in all the MIPs. After that, in a MEP which has received a LMR frame, a difference between a reception counter value at a MIP written in the currently received LMR frame and one written in the previously received LMR frame is calculated, and the frame loss over all sections is calculated.

Patent literature 3 discloses a technology described below. Initially, a link degradation index based on the number of frame losses is set. Patent literature 3 describes that a communication node shortens a cycle of CCM (Continuity Check Message) frame transmission when the link degradation index is more than a threshold value.

In the related technologies described above, the frame loss measurement method disclosed in Patent literatures 1 and 2 is particularly described by using FIG. 35. FIG. 35 is a figure showing a situation of the frame loss measurement on a path from MEP#A to MEP#B through MIP#1, MIP#2 and MIP#3, in the cycles T=1 and T=2. At this time, suppose that MEP#A transmits 100 frames at each cycle.

Here, Tx and Rx indicate a transmission counter and reception counter, respectively. That is, TxMEP#A and RxMIP#1 indicates a transmission counter of MEP#A and a reception counter of MIP#1, respectively.

The reception counter value of each MEP/MIP or the transmission counter value thereof is stored in the LMM frame, every time the LMM frame passes through each MEP/MIP.

Each MEP/MIP has a counter table. The counter value of the preceding cycle and the counter value of the current cycle are stored in the counter table.

An operation of the cycle T=1 is described as follows. Initially, MEP#A transmits the LMM frame. “0” is stored in the counter table since no frame is transmitted in the cycle T=0, and “100” that is the number of transmitted frames is stored therein in the cycle T=1. At the same time, “100” that is the transmission counter value of MEP#1 is stored in the LMM frame to be transmitted. Next, in MIP#1, “100” is also stored in the counter table in the cycle T=1, the reception counter value “100” is stored in the LMM frame and the LMM frame is transmitted.

The above processes are repeated down to MEP#B. Since no frame loss occurs in the cycle T=1, “100”, as the transmission counter value or the reception counter value of each MEP/MIP, is stored in the LMM frame when the LMM frame reaches MEP#B.

MEP#B receives the LMM frame, and updates the counter table and the LMM frame as each MIP does. After that, the LMR frame that is a reply to the LMM frame is generated, and the LMR frame is transmitted to MEP#A that is the source of the LMM frame.

Operations which are performed when the LMR frame passes through each MIP and MEP are similar to the case of the LMM frame except that the communicating direction is changed. Descriptions thereabout, therefore, are omitted.

When the LMR frame reaches MEP#A that is the destination thereof, MEP#A calculates the total number of losses of frames and losses of frames over all the sections as follows, by using the counter value stored in the LMM frame.

The frame loss in the section from a node X to a node Y is obtained by calculating the following formula.

(a counter value at a current cycle of the node X−a counter value in the preceding cycle of the node X)−(a counter value at a current cycle of the node Y−a counter value in the preceding cycle of the node Y)

Therefore, the frame loss between MEP#A and MEP#B is as follows.

|TxMEP#A(T)−TxMEP#A(T−1)|−|RxMEP#B(T)−RxMEP#A(T−1)=|100−0|−|100−0|=100−100=0

The frame loss of each section is as follows.

MEP#A−MIP#1:

|TxMEP#A(T)−TxMEP#A(T−1)|−|RxMIP#1(T)−RxMIP#1(T−1)|=|100−0|−|100−0|=100−100=0

In each section of MIP#1-MIP#2, MIP#2-MIP#3, and MIP#3-MEP#B, the number of frame losses is 0 as well.

Next, an operation of the cycle T=2 is described. In the cycle T=2, the transmission counter value or the reception counter value is stored in the LMM frame, and the counter table is updated, every time the LMM frame passes through each MEP/MIP, just like T=1.

In the cycle T=2, 50 frame losses occur in the section between MEP#A and MIP#1. Since the number of losses is 50 in the section, the reception counter value at MIP#1 is 150. The counter value stored in the LMM frame is also 150. Therefore, each reception counter value of MIP#2, MIP#3 and MEP#B is 150.

Like the cycle T=1, when the LMM frame reaches MEP#B, MEP#B updates the counter table and the LMM frame as each MIP does. After that, the LMR frame that is the reply to the LMM frame is generated, and the LMR frame is transmitted toward MEP#A that is the source of the LMM frame.

Operations which are performed when the LMR frame passes through each MIP and MEP are similar to the case of the LMM frame except that the communicating direction is changed. Descriptions thereabout are omitted.

When the LMR frame reaches MEP#A that is the destination thereof, MEP#A calculates the total number of losses of frames and losses of frames over all the sections as follows, by using the counter value stored in the LMM frame.

Therefore, the frame loss between MEP#A and MEP#B is as follows.

|TxMEP#A(T)−TxMEP#A(T−1)|−|RxMEP#B(T)−RxMEP#A(T−1)|=|200−100|−|150−100|=100−50=50

The frame loss of each section is as follows.

MEP#A-MIP#1:

TxMEP#A(T)−TxMEP#A(T−1)|−|RxMIP#1(T)−RxMIP#1(T−1)|=|200−100|−|150−100|=100−50=50,

MIP#1-MIP#2:

RxMIP#1(T)−RxMIP#1(T−1)|−|RxMIP#2(T)−RxMIP#2(T−1)|=|150−100|−|150−100|=50−50=0

In each section of MIP#2-MIP#3 and MIP#3-MEP#B, the number of frame losses is 0 as well.

As described above, it is possible to determine that the total number of frame losses between MEP#A and MEP#B is 50, and the frame loss occurs in the section of MEP#A-MIP#1.

However, the methods disclosed in Patent literatures 1 and 2 require MIP-ID and the counter value to be written into the LM frame at all the MIPs.

Therefore, if the methods disclosed in Patent literatures 1 and 2 are applied to a communication network including a plurality of MIPs, the size of the LM frame increases in proportion to the number of the included MIPs, and band efficiency of the communication network is degraded.

An example of the advantage of the invention is to increase the band efficiency of the communication network on the communication network where data loss measurement is performed.

### CITATION LIST

### Patent Literature

[Patent literature 1] Japanese Patent Application Laid-Open No. 2008-244870
[Patent literature 2] Japanese Patent Application Laid-Open No, 2010-028654
[Patent literature 3] Japanese Patent Application Laid-Open No. 2009-130474

### Non-Patent Literature

[Non-Patent literature 1] ITU-T Recommendation Y.1731

### SUMMARY

An exemplary object of the invention is to provide a communication apparatus, a communication system, and a communication method which can solve the problem described above.

A communication apparatus to an exemplary aspect of the invention, including: a counter storage unit storing a reception counter value of the apparatus when a specific frame is received; a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received; a transmission unit transmitting the specific frame; and a frame control unit adding, to the specific frame, loss information associating the number of frame losses occurring between the apparatus and the preceding apparatus with an identifier of the apparatus and to forward the specific frame to the transmission unit, when the frame loss occurs, and forwarding the specific frame to the transmission unit without adding the loss information to the specific frame, when no frame loss occurs.

A communication system to an exemplary aspect of the invention including a plurality of communication apparatus configured to transmit and receive a specific frame, wherein the communication apparatus including: a counter storage unit storing a reception counter value of the apparatus when the specific frame is received; a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received; a transmission unit transmitting the specific frame; and a frame control unit adding, to the specific frame, loss information associating the number of frame losses occurring between the apparatus and the preceding apparatus with an identifier of the apparatus and to forward the specific frame to the transmission unit, when the frame loss occurs, and forwarding the specific frame to the transmission unit without adding the loss information to the specific frame, when no frame loss occurs.

A communication method to an exemplary aspect of the invention, including: storing a reception counter value of the apparatus, when a apparatus receives a specific frame; measuring the number of frame losses occurring between the apparatus and the preceding apparatus on the basis of the reception counter value of the apparatus, a transmission counter value of a source apparatus of the specific frame included in the specific frame, and the total number of frame losses between the source apparatus and the preceding apparatus of the apparatus, when the apparatus receives the specific frame; adding, to the specific frame, loss information associating the number of frame losses occurring between the apparatus and the preceding apparatus with an identifier of the apparatus and transmitting the specific frame, when the frame loss occurs; and transmitting the specific frame without adding the loss information to the specific frame, when no frame loss occurs.

### BRIEF DESCRIPTION OF THE DRAWINGS

Exemplary features and advantages of the present invention will become apparent from the following detailed description when taken with the accompanying drawings in which:

FIG. 1 is a diagram illustrating a communication system in accordance with a first exemplary embodiment;

FIG. 2 is a diagram illustrating a communication apparatus in accordance with the first exemplary embodiment;

FIG. 3 is a diagram illustrating a configuration of an OAM control unit in accordance with the first exemplary embodiment;

FIG. 4 is a diagram illustrating an outline of operations of the first exemplary embodiment;

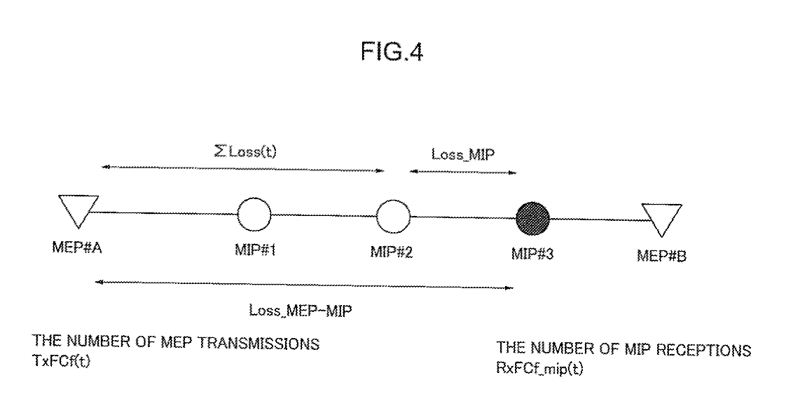

FIG. 5 is a flowchart illustrating the operations of the first exemplary embodiment;

FIG. 6 is a flowchart illustrating the operations of the first exemplary embodiment;

FIG. 7 is a flowchart illustrating the operations of the first exemplary embodiment;

FIG. 8 is a flowchart illustrating the operations of the first exemplary embodiment;

FIG. 9 is a flowchart illustrating the operations of the first exemplary embodiment;

FIG. 10 is a flowchart illustrating the operations of the first exemplary embodiment;

FIG. 11 is a diagram illustrating information which the communication apparatus of the first exemplary embodiment stores;

FIG. 12 is a diagram illustrating information which the communication apparatus of the first exemplary embodiment stores;

FIG. 13 is a diagram illustrating a format of a LM frame;

FIG. 14 is a diagram illustrating an example of operations of the first exemplary embodiment;

FIG. 15 is a diagram illustrating an example of operations of the first exemplary embodiment;

FIG. 16 is a diagram illustrating an example of operations of the first exemplary embodiment;

FIG. 17 is a diagram illustrating a configuration of an OAM control unit in accordance with a second exemplary embodiment;

FIG. 18 is a diagram illustrating an outline of the operations of the second exemplary embodiment;

FIG. 19 is a flowchart illustrating the operations of the second exemplary embodiment;

FIG. 20 is a flowchart illustrating the operations of the second exemplary embodiment;

FIG. 21 is a flowchart illustrating the operations of the second exemplary embodiment;

FIG. 22 is a flowchart illustrating the operations of the second exemplary embodiment;

FIG. 23 is a flowchart illustrating the operations of the second exemplary embodiment;

FIG. 24 is a diagram illustrating an example of operations of the second exemplary embodiment;

FIG. 25 is a diagram illustrating an example of operations of the second exemplary embodiment;

FIG. 26 is a diagram illustrating an example of operations of the second exemplary embodiment;

FIG. 27 is a diagram illustrating an example of operations of a third exemplary embodiment;

FIG. 28 is a diagram illustrating an example of operations of a third exemplary embodiment;

FIG. 29 is a flowchart illustrating the operations of the third exemplary embodiment;

FIG. 30 is a flowchart illustrating the operations of the third exemplary embodiment;

FIG. 31 is a flowchart illustrating the operations of the third exemplary embodiment;

FIG. 32 is a diagram illustrating a configuration of an OAM control unit in accordance with the third exemplary embodiment;

FIG. 33 is a diagram illustrating a configuration of a communication apparatus in accordance with a fourth exemplary embodiment;

FIG. 34 is a flowchart illustrating the operations in accordance with the fourth exemplary embodiment; and

FIG. 35 is a diagram illustrating an example of operations of the background art.

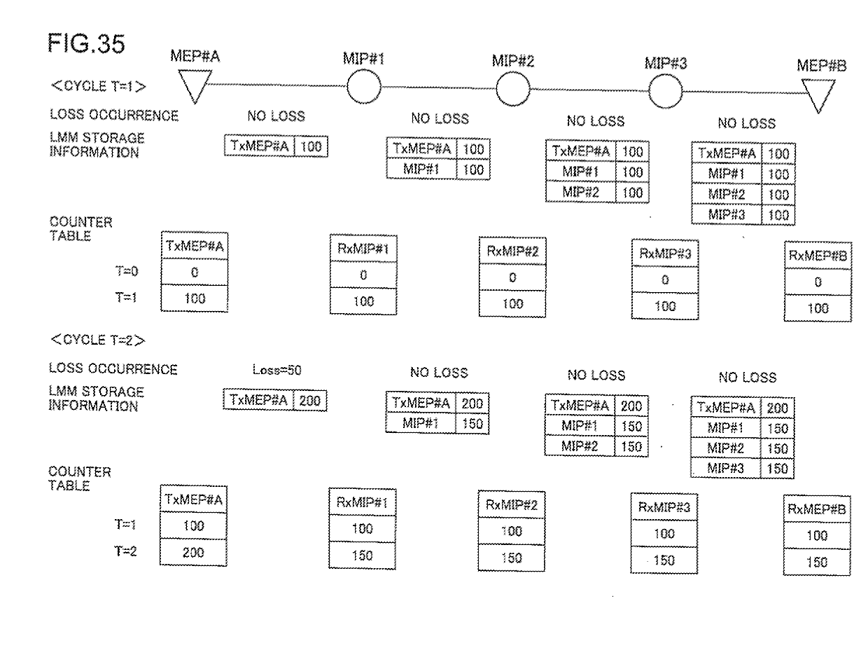

### EXEMPLARY EMBODIMENT

Exemplary embodiments 1 to 4 of the present invention are described below in detail by using drawings.

### First Exemplary Embodiment

### Configuration

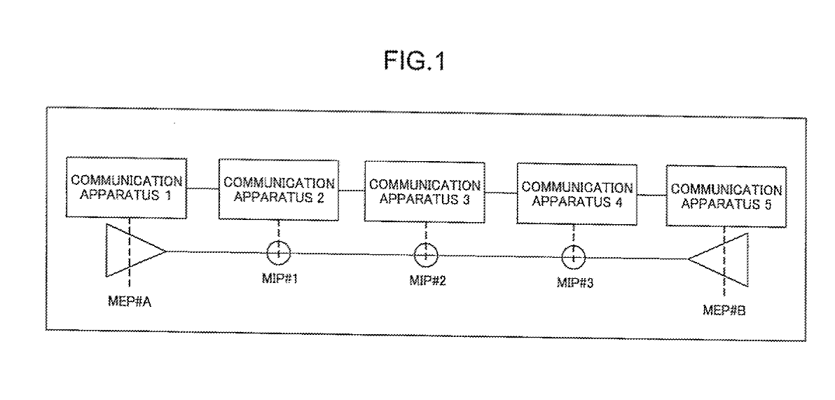

The first exemplary embodiment in accordance with the present invention is described below in detail by using drawings. FIG. 1 is a diagram illustrating a system in accordance with the first exemplary embodiment. Communication apparatuses 2, 3 and 4 relaying communications are placed between a communication apparatus 1 performing a LM measurement and a communication apparatus 5 opposite thereto.

Each of the communication apparatuses 1 and 5 is placed as a MEP, and each of the communication apparatuses 2, 3 and 4 is placed as a MW. As shown in FIG. 1, the communication apparatuses 1, 2, 3, 4 and 5 correspond to MEP#A, MIP#1, MIP#2, MIP#3 and MEP#B, respectively.

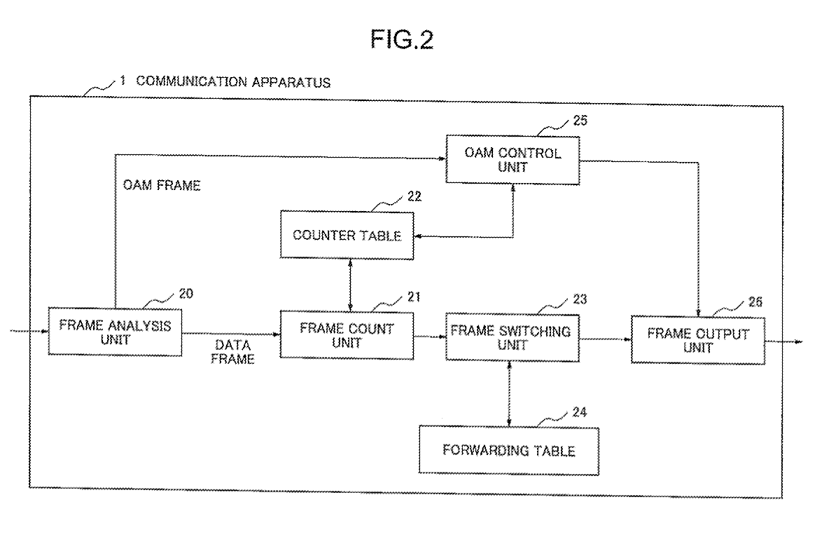

FIG. 2 is a block diagram illustrating a configuration of the communication apparatus 1.

The configuration of the communication apparatus 1 illustrated in FIG. 2 is similar to that of each of communication apparatuses 2, 3, 4 and 5. Therefore, descriptions thereof are omitted.

As shown in FIG. 2, the communication apparatus 1 includes a frame analysis unit 20, a frame count unit 21, a counter table 22, a frame switching unit 23, a forwarding table 24, OAM control unit 25 and a frame output unit 26.

The frame analysis unit 20 determines types of frames which the communication apparatus 1 receives. The frame analysis unit 20 forwards a frame determined as a data frame to the frame count unit 21 and forwards a frame determined as an OAM frame to the OAM control unit 25. The frame count unit 21 counts the number of entered data frames and forwards the data frames to the frame switching unit 23. The counter table 22 holds the number of data frames (local counter value) counted by the frame count unit 21. On receiving the data frames, the frame switching unit 23 refers to the forwarding table 24, obtains output port information and forwards the data frames to the frame output unit 26. The forwarding table 24 stores the output port information associated with frame destination address information.

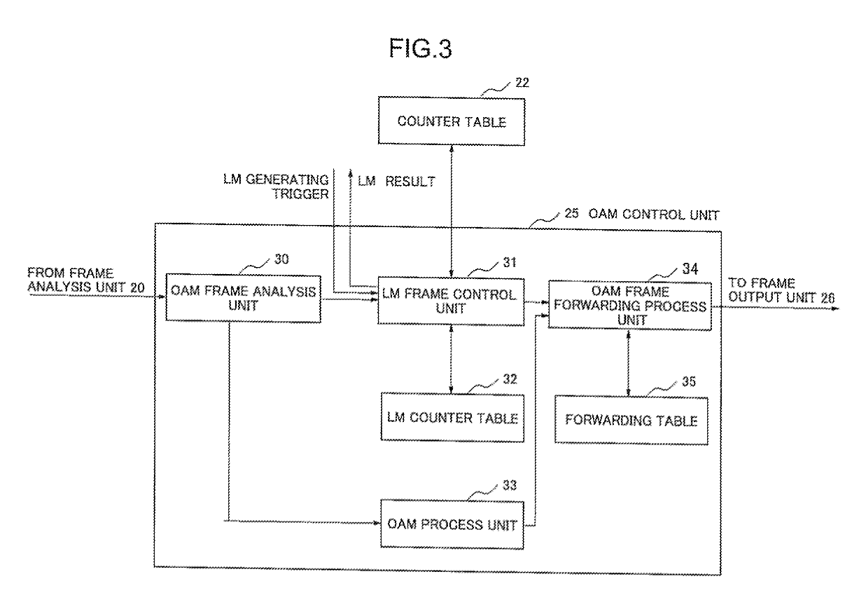

The OAM control unit 25 performs predetermined OAM control based on types of the OAM frame received from the frame analysis unit 20. The predetermined OAM control includes LM, and further includes CC, LB, LT, and the like described in the background art. In the LM process, predetermined LM control is performed with reference to a counter of the counter table 22. After the predetermined OAM control is performed, the OAM frame is forwarded to the frame output unit 26. A detailed configuration of the OAM control unit 25 is described below by using FIG. 3. The frame output unit 26 forwards the data frame received from the frame switching unit 23 or the OAM frame received from the OAM control unit 25, to a predetermined output port.

FIG. 3 shows a configuration of the OAM control unit 25. The OAM control unit 25 includes an OAM frame analysis unit 30, a LM frame control unit 31, a LM counter table 32, an OAM process unit 33, an OAM frame forwarding process unit 34, and a forwarding table 35.

The OAM frame analysis unit 30 analyzes the OAM frame received from the frame analysis unit 20. If the analysis shows that the received frame is a LM frame, the OAM frame analysis unit 30 forwards the LM frame to the LM frame control unit 31. If the received OAM frame is one of the other OAM frames, the OAM frame analysis unit 30 forwards the OAM frame to the OAM process unit 33.

The LM frame control unit 31 performs frame loss occurrence determination and writes the number of losses into the frame when the frame loss is detected. In this operation, processes thereof are different depending on if the communication apparatus shown in the first exemplary embodiment is a source MEP (communication apparatus 1 in FIG. 1), a relaying MIP (communication apparatuses 2, 3 and 4 in FIG. 1) or an opposite MEP (communication apparatus 5 in FIG. 1). An outline of processes of the LM frame control unit 31 is described here, and detail thereof is described below.

### (Outline of Operations)

Initially, a case in which the communication apparatus is the source MEP is described. On receiving a LMM execution trigger from an externally designed interface (not shown in drawings) or the like, the communication apparatus generates a LMM frame and, at the same time, forwards the LMM frame to the OAM frame forwarding process unit 34. On receiving a LMR frame from the OAM frame analysis unit 30, the LM frame control unit 31 terminates the LMR frame. The LM frame control unit 31 further calculates the end-to-end (between end points) frame loss information and frame loss information in each section, and sends the result to the outside (memory, external output interface, and the like).

Next, a case in which the communication apparatus is the relaying MIP is described. On receiving the LM frame, the communication apparatus performs frame loss determination by using a transmission counter value of a source MIP stored in the frame, information on the frame loss which occurs down to the preceding MIP, a local counter value obtained by referring to the counter table 22, a transmission counter value of the source MEP obtained by referring to the LM counter table 32, and history information of the local counter value. When it is determined that a frame loss occurs, MIP-ID of the apparatus and the number of frame losses are written in the LM frame. Next, The LM frame control unit 31 forwards the LM frame to the OAM frame forwarding process unit 34.

When the communication apparatus is an opposite MEP, the LM frame control unit 31 terminates the LMM frame if the communication apparatus receives the LMM frame. After that, the LM frame control unit 31 generates the LMR frame by using information in the LMM frame and forwards the LMR frame to the OAM frame forwarding process unit.

The LM counter table 32 stores the transmission counter value of the source MEP and a history of the local counter value.

On receiving the OAM frame other than the LM frame from the OAM frame analysis unit 30, the OAM process unit 33 performs a predetermined OAM process and forwards the OAM frame to the OAM frame forwarding process unit 34. Since the predetermined OAM process other than LM is a well known technology as described above, descriptions thereof is omitted here.

In the first exemplary embodiment, LM process-related functions (LM frame control unit 31, LM counter table 32) are described as a functional blocks different from the OAM process unit 33. The first exemplary embodiment is however not limited to this configuration. The LM process-related functions, like the LM frame control unit 31 and the LM counter table 32, may be included in the OAM process unit 33.

The forwarding table 35 stores the destination address information of the OAM frame and the output port information associated with each other.

The communication apparatus can recognize that the apparatus is the source MEP or the opposite MEP as follows. It is common that each MEP/MIP is managed by a management apparatus other than the MEP/MIP on a network. When the management apparatus instructs a MEP to transmit the LMM frame, the MEP which transmits the LMM frame can recognize that the MEP itself is the source MEP.

The opposite MEP determines that the frame is addressed to the communication apparatus itself based on a MEG level and a MAC (Media Access Control) address. If a MEP receives a frame addressed to the communication apparatus itself, the MEP is the opposite MEP.

(Detailed Operations)

Detailed operations performed in the frame loss measurement of the first exemplary embodiment are described. Initially, a frame loss detecting operation in accordance with the first exemplary embodiment is described.

In the LM process disclosed in Non-patent literature 1, the end-to-end frame loss between MEP#A and MEP#B is calculated according to the formulas (1) and (2). Only far-end direction from MEP#A to MEP#B is described below.

The end-to-end frame loss between MEP#A and MEP#B is calculated by the formula (1),

Loss_{—}E2E=|TxFCf(t)−TxFCf(t−1)|−|RxFCf(t)−RxFCf(t−1)| formula (1)

wherein,

TxFCf(t): transmission counter value of source MEP#A at time t,
TxFCf(t−1): transmission counter value of source MEP#A at time t−1,
RxFCf(t): reception counter value of opposite MEP#B at time t,
RxFCf(t−1): reception counter value of opposite MEP#B at time t−1.

If the formula (1) is applied to the frame loss of MIP-MIP (e.g. MIP#2 MIP#3), the following formula is derived,

Loss_MIP=|TxFCf_mip′(t)−TxFCf_mip′(t−1)|−|RxFCf_mip(t)−RxFCf_mip(t−1)| formula (2)

wherein,

TxFCf_mip′(t): the transmission counter value of MIP#2 prior to the measuring object, MIP#3, at time t,

TxFCf_mip′(t−1): the transmission counter value of the preceding MIP#2 at time t−1,

RxFCf_mip(t): the reception counter value of the measuring object, MIP#3 at time t,

RxFCf_mip(t−1): the reception counter value of the measuring object, MIP#3 at time t−1.

In the formula (2), MIP#2 is described as “mip′”, and MIP#3 is described as “mip”, for generalization.

In the first exemplary embodiment, MIP#1 to MIP#3 writes a counter value into the LM frame, when the frame loss is detected. Detail thereof is described below. Therefore, when the measuring object is MIP#3, the transmission counter value of MIP#2 prior to the measuring object MIP#3 that is the first term of the formula (2) is not identified if no frame loss is detected in the MIP#2. Therefore, the frame loss between MIP and MIP cannot be calculated by the formula (2).

In the first exemplary embodiment, each of MIP#1, MIP#2 and MIP#3 stores the number of losses in the LM frame when the frame loss is detected, and sends it to the next apparatus. Under the operation, the frame loss of MIP-MIP is calculated as the following formula (3),

Loss_MIP=Loss_MEP−MIP−ΣLoss(t)=TxFCf(t)−TxFCf(t−1)|−|RxFCf_mip(t)−RxFCf_mip(t−1)|−Loss(t) formula (3),

wherein,

|TxFCf(t)−TxFCf(t−1)|: the number of frames which the source MEP#A transmits at time t,
RxFCf_mip(t)−RxFCf_mip(t−1): the number of frames which MIP#3 receives at time t,
Σ Loss (t): the total number of losses which occur between the source MEP#A and the preceding MIP#2.

The formula (3), therefore, gives the number of losses which occur between the preceding MIP#2 and the measuring object MIP#3.

TxFCf(t) is a value informed by LM, TxFCf(t−1) has only to hold the history of the cycle (t−1) prior to the cycle t.

RxFCf_mip(t) is a local counter value which is stored in the counter table 22 of MIP#3, and RxFCf_mip(t−1) is a value in the preceding cycle. In each MEP/MIP, the history of the preceding cycle has only to be held.

As described above, Σ Loss (t) indicates the total number of losses which occur between the source MEP#A and the preceding MIP#2. When the frame loss is detected, each MIP stores the number of losses which is calculated into the LMM frame and sends the number thereof to the subsequent apparatus. Therefore, each MIP can refer to the total number of losses calculated by the preceding MIPs in the received LMM frame and obtain it.

Here, the frame loss deriving formula at a MIP in the direction from the opposite MEP#B to the source MEP#A (near-end direction), a loss between MIP#2→MIP#1 for example, is obtained by changing the formula (3) of the far-end direction, as follows,

Loss_MIP=|TxFCb(t)−TxFCb(t−1)|−|RxFCb_mip(t)−RxFCb_mip(t−1)|−ΣLoss′(t) formula (4),

wherein,

TxFCb(t): the transmission counter value of the opposite MEP#B at time t,

TxFCb(t−1): the transmission counter value of the opposite MEP#B at time t−1,

RxFCb_mip(t): the reception counter value of the test object MIP#1 at time t,

RxFCb_mip(t−1): the reception counter value of the test object MIP#1 at time t−1,

Σ Loss′ (t): the total number of losses which occur between the opposite MEP#B and the preceding MIP#2.

Configurations and operations of apparatuses which perform the frame loss measurement using the frame loss detecting method described above are described below by using drawings.

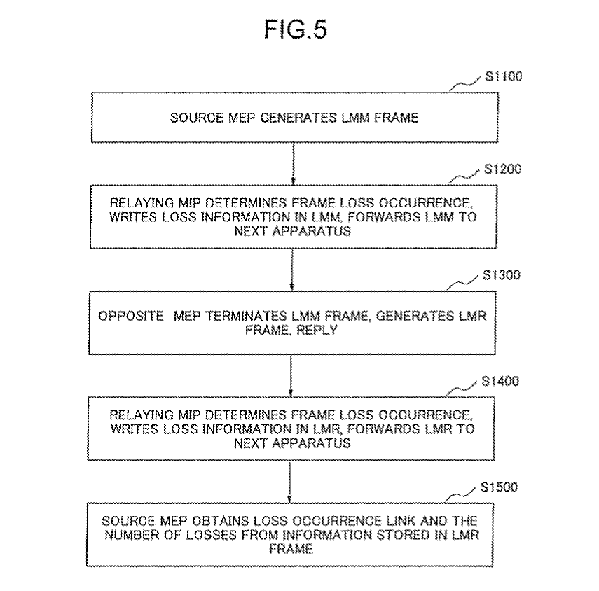

FIG. 5 is a flowchart illustrating a flow of entire operations of the first exemplary embodiment. A case in which MEP#A transmits the LMM frame, in the configuration shown in FIG. 1, is described below, as an example.

In step S1100, the source MEP#A generates the LMM frame and forwards it to the next apparatus (MIP#1).

In step S1200, relaying MIP#1, MIP#2 and MIP#3 determines whether the frame loss occurs, on receiving the LMM frame. If occurrence of the frame loss is determined, information on the number of frame losses is stored in the LMM frame and forwarded to the next apparatus (MIP#2, MIP#3, MEP#B).

In step S1300, the opposite MEP#B terminates the LMM frame, generates the LMR frame based on the information in the LMM frame, and forwards the LMR frame to the next apparatus (MIP#3).

In step S1400, relaying MIP#3, MIP#2 and MIP#1 determines whether the frame loss occurs, on receiving the LMR frame. If the frame loss occurs, the information on the number of frame losses is stored in the LMR frame and transferred to the next apparatus (MIP#2, MIP#1, MEP#A).

Finally, in step S1500, on receiving the LMR frame, the source MEP#A calculates the number of end-to-end frame losses and the number of frame losses in each section based on the information stored in the LMR frame.

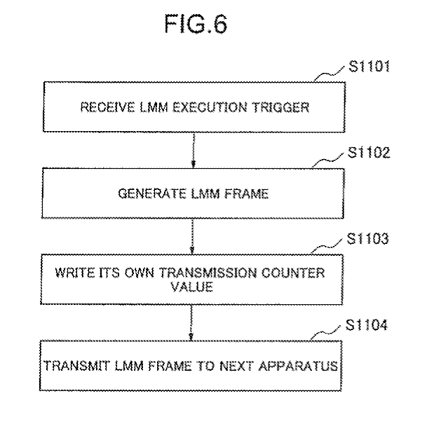

Detailed operations in each of the steps are described below by using drawings. FIG. 6 illustrates detailed operations in step S1100 of FIG. 5 (LMM generating flow in the source MEP#A).

The LM frame control unit 31 receives a LMM execution trigger (step S1101).

Next, the LM frame control unit 31 generates the LMM frame (step S1102).

The LM frame control unit 31 refers to the counter table 22, obtains the transmission counter value: TxFCf(t), and writes it in the LMM frame (step S1103).

Finally, the LMM frame is forwarded to the OAM frame forwarding process unit 34. The OAM frame forwarding process unit 34 refers to the forwarding table 35, determines the output port, forwards the LMM frame to the frame output unit 26 and forwards it to the next apparatus (step S1104).

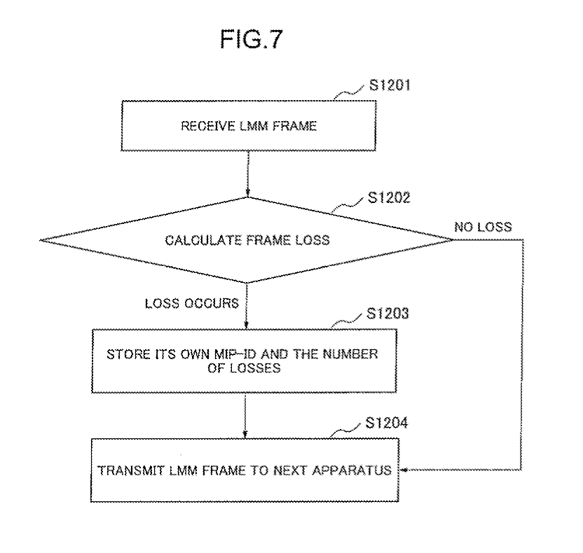

FIG. 7 shows a detailed flow in step S1200 in FIG. 5 (LMM relaying in the relaying MIP#1 to MIP#3). In step S1201, the LM frame control unit 31 receives the LMM frame from the OAM frame analysis unit 30.

In step S1202, the LM frame control unit 31 calculates the frame loss. A deriving formula for frame loss calculation is the formula (3).

The LM frame control unit 31 obtains parameters which are necessary for calculation of the formula (3), from the followings,

TxFCf(t): from the received LMM frame,

TxFCf(t−1): by referring to the LM counter table 32,

RxFCf_mip(t): by referring to the LM counter table 22,

RxFCf_mip(t−1): by referring to the LM counter table 32,

Σ Loss (t): from the received LMM frame.

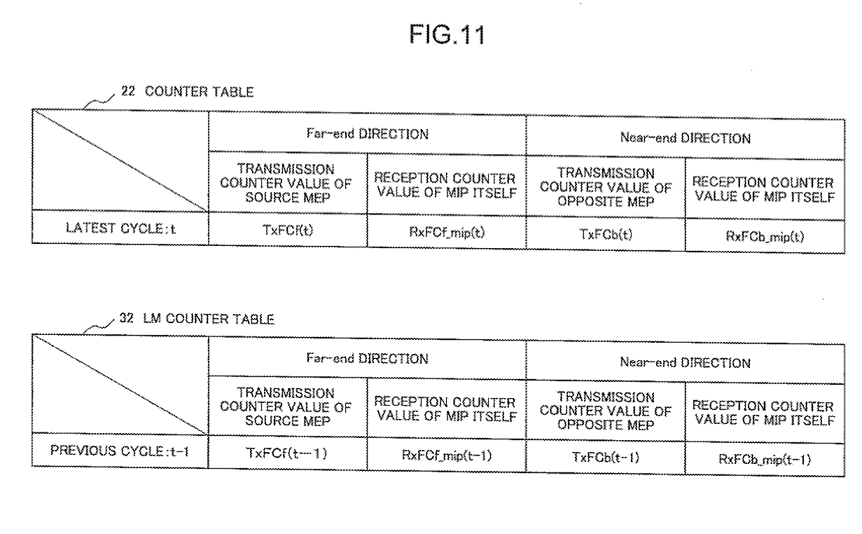

By using FIG. 11, the LM counter table 32 and the counter table 22 from which the parameters are obtained are described in detail. FIG. 11 illustrates configurations of the LM counter table 32 and the counter table 22. The counter table 22 holds the information on counter values at the current cycle t. Specifically, the counter table 22 holds the transmission counter value TxFCf(t) of the source MEP and the reception counter value RxFCf_mip(t) of the apparatus, as the information on counter values of the far-end direction. The counter table 22 further holds the transmission counter value TxFCb(t) of the opposite MEP of the near-end direction and the reception counter value RxFCb_mip(t) of the apparatus.

The LM counter table 32 holds the history of the information on counter values at the preceding cycle t−1. Specifically, the LM counter table 32 holds the transmission counter value TxFCf(t−1) of the source MEP of the far-end direction and the reception counter value RxFCf_mip(t−1) of the apparatus, and further holds the transmission counter value TxFCb(t−1) of the opposite MEP of the near-end direction and the reception counter value RxFCb_mip(t−1) of the apparatus.

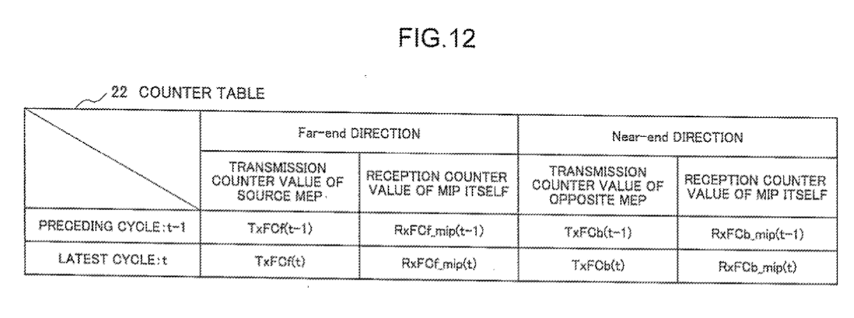

As shown in FIG. 12, the counter values at the current cycle t and the history of the counter values at the preceding cycle t−1 may be held in the counter table 22 at the same time.

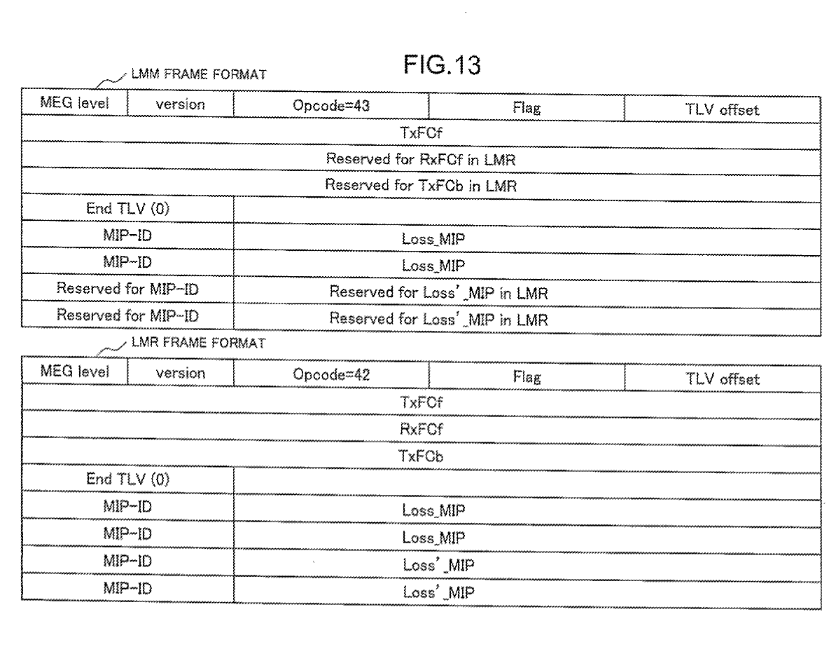

FIG. 13 illustrates frame formats of the LMM/LMR frames. The formats shown in FIG. 13 includes the LM frame format defined in Non-patent literature 1 and a field which stores MIP-ID of MIP where the frame loss occurs and the number of the frame losses which are associated with each other.

If it is supposed that frame losses do not occur in every sections at the same time, then the number of fields storing MIP-ID and the number of frame losses may be less than the number of MIPs. In such case, the frame size may be smaller than the frame format described in Non-patent literature 1.

According to FIG. 7, detailed operations of step S1200 of FIG. 5 are described.

In frame loss calculation in step S1202, when the frame loss is detected, step S1203 is executed. In step S1203, the LM frame control unit 31 writes MIP-ID of the apparatus and the number of frame losses into the LMM frame, and forwards the frame to the OAM frame forwarding process unit 34.

Next, in step S1204, the OAM frame forwarding process unit 34 refers to the forwarding table 35 and determines the output port. After that, the OAM frame forwarding process unit 34 forwards the LMM frame to the frame output unit 26. The frame output unit 26 forwards the LMM frame to the next apparatus.

In step S1202, when no frame loss is detected, a frame forwarding process in step S2-4 is directly executed.

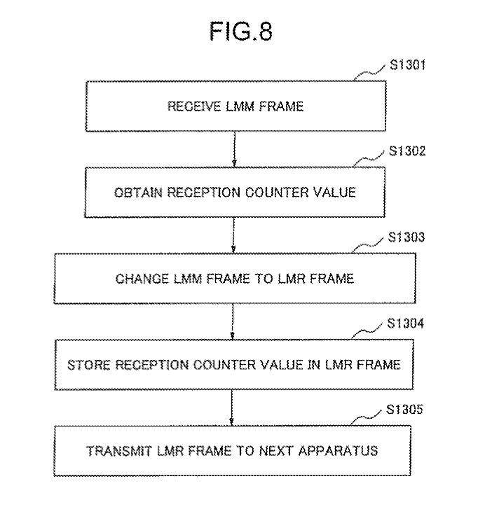

Detailed operations in step S1300 of FIG. 5 are described. FIG. 8 is a flowchart illustrating detailed operations in step S1300 of FIG. 5 (LMM frame termination and LMR frame generation of the opposite MEP#B).

In step S1301, the LM frame control unit 31 receives the LMM frame from the OAM frame analysis unit 30. Next, in step S1302, the reception counter value RxFCf(t) is obtained by referring to the counter table 22. In step S1303, the LM frame control unit 31 terminates the LMM frame and generates the LMR frame using the information in the LMM frame. In step S1304, the LM frame control unit 31 stores the reception counter value RxFCf(t) obtained in step S1302 into the generated LMR frame and forward the LMR frame to the OAM frame forwarding process unit 34. In step S1305, the OAM frame forwarding process unit 34 refers to the forwarding table 37, determines the output port, forwards the LMR frame to the frame output unit 26, and forwards it to the next apparatus.

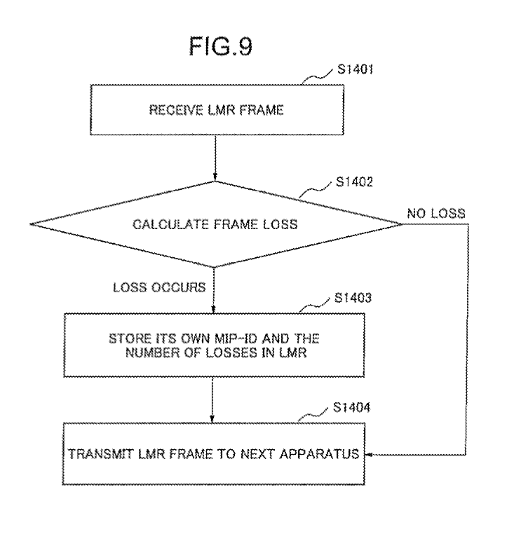

Detailed operations in step S1400 of FIG. 5 are described. FIG. 9 is a flowchart illustrating detailed operations in step S1400 of FIG. 5 (LMR frame relaying in relaying MIP#3, MIP#2 and MIP#1).

In step S1401, the LM frame control unit 31 receives the LMR frame from the OAM frame analysis unit 30. Next, in step S1402, the frame loss is calculated. A deriving formula for the frame loss calculation is the formula (4) of the near-end direction.

The LM frame control unit 31 obtains parameters which are used for the formula (4), from the followings,

TxFCb(t) from the received LMR frame,

TxFCb(t−1): by referring to the LM counter table 32,

RxFCb_mip(t): by referring to the LM counter table 22,

RxFCb_mip(t−1): by referring to the LM counter table 32,

Σ Loss′ (t): from the received LMR frame like the Loss (t).

In the frame loss calculation in step S1402, step S1403 is executed when the frame loss is detected.

In step S1403, the LM frame control unit 31 writes MIP-ID of the apparatus and the number of frame losses into the LMR frame, and forwards the LMR frame to the OAM frame forwarding process unit 34.

Next, in step S1204, the OAM frame forwarding process unit 34 refers to the forwarding table 35 and determines the output port. After that, the OAM frame forwarding process unit 34 forwards the LMR frame to the frame output unit 26. The frame output unit 26 forwards the LMR frame to the next apparatus.

In step S1402, when no frame loss is detected, a frame forwarding process in step S4-4 is directly executed.

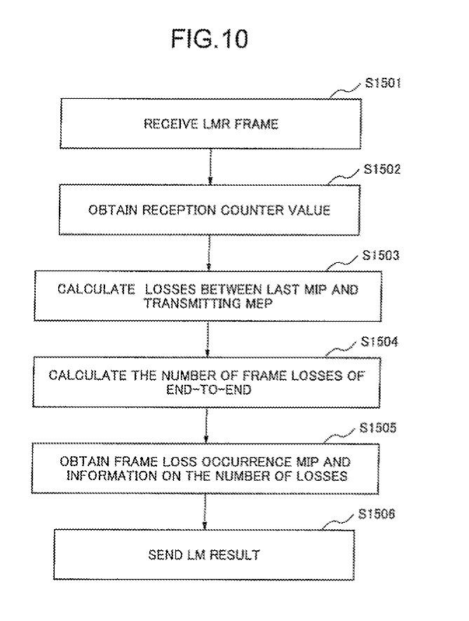

Finally, detailed operations in step S1500 of FIG. 5 are described. FIG. 10 is a flowchart illustrating detailed operations in step S1500 of FIG. 5 (LMR frame termination in the source MEP#A).

In step S1501, the LM frame control unit 31 receives the LMR frame from the OAM frame analysis unit 30. Next, in step S1502, the reception counter value RxFCb(t) is obtained by referring to the counter table 22. In step S1503, the LM frame control unit 31 calculates the number of frame losses which occur between the MIP which the LMR frame finally passes through and the source MEP (between MIP#1 and MEP#A) by using the formula (4).

In step. S1504, the LM frame control unit 31 calculates the end-to-end (between MEP#A and MEP#B) frame loss by using the formula described in Non-patent literature 1. The deriving formula is the formula defined in Non-patent literature 1, that is,

Loss(far-end)=|TxFCf(t)−TxFCf(t−1)|−|RxFCf(t)−RxFCb(t−1)| (equal to formula (1))

Loss(near-end)=|TxFCb(t)−TxFCb(t−1)|−|RxFCb(t)−RxFCb(t−1) formula (5)

Next, in step S1505, the LM frame control unit 31 obtains information on MIP-ID which generates the frame loss and the number of losses from information stored in the LMR frame. The order of step S1504 and step S1505 may be reversed.

In step S1506, the end-to-end frame loss information and the frame loss information in each section, which are LM results, are sent to the outside (memory, external output interface, and the like).

According to operations from step S1100 to step S1500, the management apparatus MEP#A can measure the number of end-to-end frame losses and the number of frame losses in each section.

In the first exemplary embodiment, in step S1200 and step S1400, frame loss occurrence can be detected from the transmission counter value of the source MEP and the reception counter value of the MIP itself, and the MIP-ID information and the information on the number of losses are transmitted when the loss occurs. Since two pieces of the information are not written when no frame loss occurs, a frame size can be decreased and band efficiency can be enhanced.

Additionally, in step S1200 and step S1400, the frame loss occurring MIP calculates and transmits the number of frame losses. Therefore, in step S1500, referring to storage information in the LMR frame and calculating the frame loss between the last MIP where the LMR passes through and the source MEP, the source MEP can obtain the frame loss occurring MIP and the information on the number of losses. Accordingly, amount of calculation at each MEP may be reduced.

### <Example of Operations (1)>

Operations of the first exemplary embodiment are described below by using specific numerical examples.

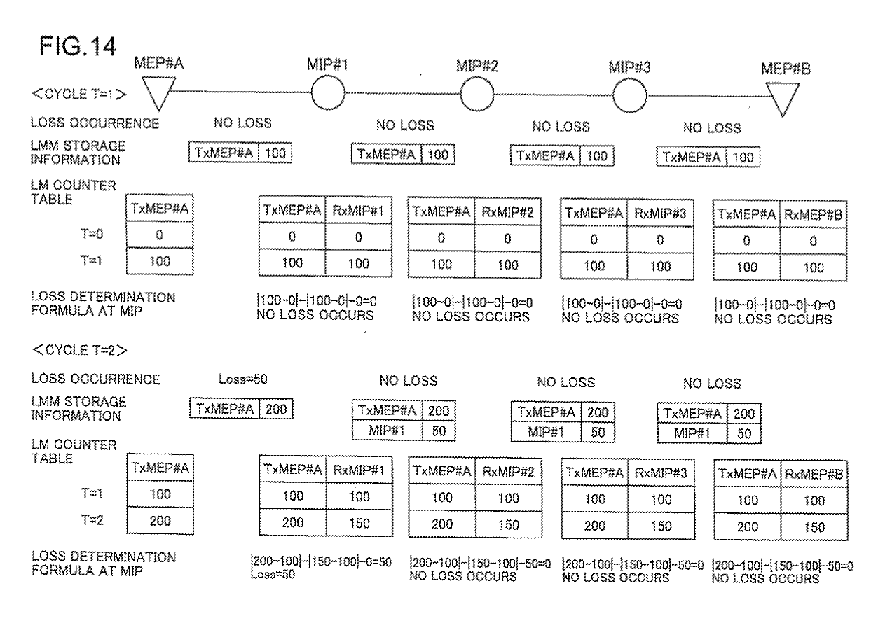

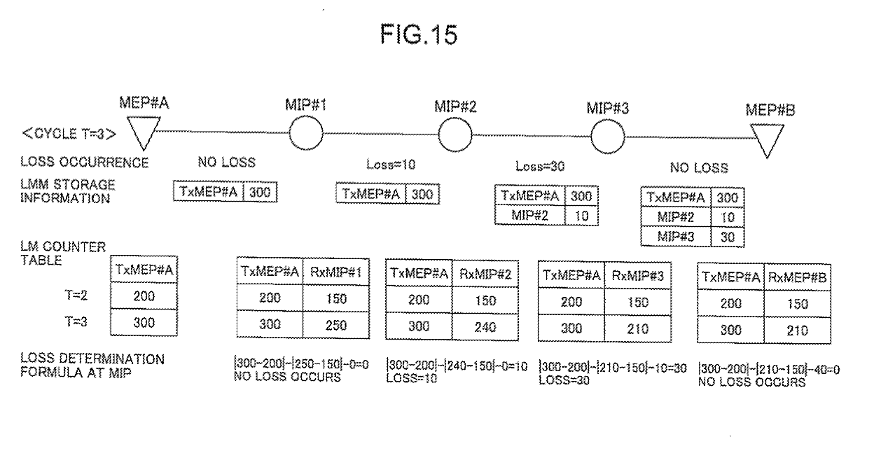

FIG. 14 and FIG. 15 illustrate calculations of the counter value stored in the LMM frame at the time of LM execution on the network in FIG. 1, the information on the number of losses, the storage information in the LM counter table 32 at each MEP/MIP, and frame loss determination at each MEP/MIP. In FIG. 14, an example of the far-end direction is only described, for simplification. Additionally, it is based on the premise that new frame loss does not occur in the near-end direction.

FIG. 14 shows numerical examples in cycles T=1, 2. FIG. 15 shows numeric values of T=3, at the time of LM execution, as an example in which frame losses occur in a plurality of sections.

The source MEP#A transmits 100 frames in each cycle. Losses of 50 frames occur between MEP#A and MIP#1 in the cycle T=2. Losses of 10 frames occur between MIP#1 and MIP#2 and losses of 30 frames occur between MIP#2 and MIP#3, in the cycle T=3.

Storage information in the LMM frame in each cycle, and transition of conditions in the LM counter table and frame loss measurement at each MEP/MIP is described in detail, by using numerical examples.

### <Cycle T=1>

### (Frame Loss Determination at MIP#1)

Details of frame loss determination at MIP#1 in the cycle T=1 are described below.

On receiving the LMM frame from MEP#1, MIP#1 obtains the transmission counter value of MEP#A (TxMEP#A) in the current cycle T=1, that is TxFCf(t)=100, from the storage information in the received LMM frame. At the same time, MIP#1 obtains ΣLoss (t)=0 (the number of losses between MEP#A and the preceding MIP) from the LMM frame.

Next, MIP#1 obtains the transmission counter value of MEP#A (TxMEP#A) in the preceding cycle T=0, that is TxFCf(t−1)=0, from the LM counter table 32. At the same time, MIP#1 obtains the reception counter value of MIP#1 (RxMIP#1) in the preceding cycle T=0, that is RxFCf_mip(t−1)=0, from the LM counter table 32.

MIP#1 obtains the reception counter value of MIP#1 in the current cycle T=1, that is RxFCf_mip(t)=100, from the counter table 22.

Next, the number of frame losses between MEP#A and MIP#1 which is calculated by the formula (4) is as follows,

|TxMEP#A(t)−TxMEP#A(t−1)|−|RxMIP#1(t)−RxMIP#1(t−1)|−ΣLoss(t)=|100−0|−|100−0|−0=0.

It is proved that the number of frame losses between MEP#A and MIP#1 is zero, that is, no loss occurs.

(Frame Loss Determination at MIP#2, MIP#3 and MEP#B)

Conditions in frame loss determination at MIP#2, MIP#3 and MEP#B are similar to that of MIP#1, since no frame loss occurs in any section. Therefore, descriptions on the frame loss determination at MIP#2, MIP#3 and MEP#B are omitted.

(Frame Loss Measurement at Source MEP#A)

When the LMM frame reaches MEP#B, MEP#B transmits the LMR frame toward MEP#A as described in the first exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (1), the following formula is obtained,

Loss(far-end)=−TxFCf(t)−TxFCf(t−1)|−|RxFCf(t)−RxFCf(t−1)|=|100−0|−|100−0|=0.

From the result, it is proved that no frame loss occurs in the end-to-end.

Next, the number of frame losses is measured in each section. Since a frame loss occurrence MIP-ID is not written in the LMR frame received by MEP#A (or since no loss occurs over the end-to-end), it is determined that no loss occurs in each section.

### <Cycle T=2>

A numerical example of frame loss determination at each MEP/MIP in cycle T=2 is described. In the cycle T=2, the frame loss occurs in the section of MEP#A-MIP#1, and the number of the losses is 50.

(Frame Loss Determination at MIP#1)

Details of frame loss determination at MIP#1 in the cycle T=2 are described below.

On receiving the LMM frame from MEP#1, MIP#1 obtains the transmission counter value of MEP#A (TxMEP#A) in the current cycle T=2, that is TxFCf(t)=200, from the storage information in the received LMM frame. At the same time, MIP#1 obtains ΣLoss (t)=0 (the total number of losses between MEP#A and the preceding MIP) from the LMM frame.

Next, MIP#1 obtains the transmission counter value of MEP#A (TxMEP#A) in the preceding cycle T=1, that is TxFCf(t−1)=100, from the LM counter table 32. At the same time, MIP#1 obtains the reception counter value of MIP#1 (RxMIP#1) in the preceding cycle T=1, that is RxFCf_mip(t−1)=100, from the LM counter table 32.

MIP#1 obtains the reception counter value of MIP#1 in the current cycle T=2, that is RxFCf_mip(t)=150, from the counter table 22.

Next, the number of frame losses between MEP#A and MIP#1 which is calculated by the formula (4) is as follows,

|TxMEP#A(t)−TxMEP#A(t−1)|−|RxMIP#1(t)−RxMIP#1(t−1)|−ΣLoss(t)=|200−100|−|200−150|−0=50.

It is, therefore, proved that the frame loss occurs between MEP#A and MIP#, and the number of losses is 50.

Finally, MIP#1 stores MIP-ID thereof and the number of losses in the LMM frame, and transmits the LMM frame to the next apparatus (MIP#2) when a loss occurs in the MIP#1.

(Frame Loss Determination at MIP#2)

Details of frame loss determination at MIP#2 in the cycle T=2 are described below.

On receiving the LMM frame from MEP#1, MIP#2 obtains the transmission counter value of MEP#A (TxMEP#A) in the current cycle T=2, that is TxFCf(t)=200, from the storage information in the received LMM frame. At the same time, MIP#2 obtains Σ Loss (t)=50 (the total number of losses between MEP#A and the preceding MIP) from the LMM frame.

The value of ΣLoss (t) is 50, because the frame loss is found in MIP#1, that is the preceding MIP, and the number of frame losses, that is 50, is stored in the LMM frame.

Next, MIP#2 obtains the transmission counter value of MEP#A (TxMEP#A) in the preceding cycle T=1, that is TxFCf(t−1)=100, from the LM counter table 32. At the same time, MIP#2 obtains the reception counter value of MIP#2 (RxMIP#2) in the preceding cycle T=1, that is RxFCf_mip(t−1)=100, from the LM counter table 32.

MIP#2 obtains the reception counter value of MIP#2 in the current cycle T=2, that is RxFCf_mip(t)=150, from the counter table 22.

Next, the number of frame losses between MEP#1 and MIP#2 which is calculated by the formula (4) is as follows,

|TxMEP#A(t)−TxMEP#A(t−1)|−|RxMIP#2(t)−RxMIP#2(t−1)|−ΣLoss(t)=|200−100|−|150−100|−50=0.

It is, therefore, proved that the number of frame losses between MIP#1 and MIP#2 is zero, that is, no frame loss occurs in the section.

(Frame Loss Determination at MIP#3 and MEP#B)

Frame loss determination at MIP#3 and MEP#B is similar to that of MIP#2 described above, since no frame loss occurs in any sections related to MIP#3 and MEP#B. Descriptions on the frame loss determination at MIP#3 and MEP#B are omitted here.

(Frame loss measurement at source MEP#A)

When the LMM frame reaches MEP#B, MEP#B transmits the LMR frame toward MEP#A as described in the first exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (1), the following formula is obtained,

Loss(far-end)=|TxFCf(t)−TxFCf(t−1)|−|RxFCf(t)−RxFCf(t−1)|=|200−100|−|150−100=50.

Therefore, it is proved that the number of frame losses of the end-to-end, that is, between MEP#A and MEP#B, is 50.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it may refer to that. Specifically, as shown in FIG. 14, MIP#1 is stored in the LMR frame as the frame loss occurrence MIP-ID, the number of losses thereof is 50. Accordingly, it is identified that 50 frame losses occur between MEP#A and MIP#1.

### <Cycle T=3>

A numerical example of frame loss determination at each MEP/MIP in cycle T=3 is described by referring to FIG. 15. In the cycle T=3, the frame losses occur in the sections of MIP#1-MIP#2 and MIP#2-MIP#3, and the number of the losses in the sections are 10, and 30, respectively.

(Frame Loss Determination at MIP#1)

Details of frame loss determination at MIP#1 in the cycle T=3 are described below.

On receiving the LMM frame from MEP#A, MIP#1 obtains the transmission counter value of MEP#A (TxMEP#A) in the current cycle T=3, that is TxFCf(t)=300, from the storage information in the received LMM frame. At the same time, MIP#1 obtains Σ Loss (t)=0 (the total number of losses between MEP#A and the preceding MIP) from the LMM frame.

Next, MIP#1 obtains the transmission counter value of MEP#A (TxMEP#A) in the preceding cycle T=2, that is TxFCf(t−1)=200, from the LM counter table 32. At the same time, MIP#1 obtains the reception counter value of MIP#1 (RxMIP#1) in the preceding cycle T=2, that is RxFCf_mip(t−1)=150, from the LM counter table 32.

MIP#1 obtains the reception counter value of MIP#1 in the current cycle T=3, that is RxFCf_mip(t)=250, from the counter table 22.

Next, the number of frame losses between MEP#A and MIP#1 which is calculated by the formula (4) is as follows,

|TxMEP#A(t)−TxMEP#A(t−1)|−|RxMIP#1(t)−RxMIP#1(t−1)|−ΣLoss(t)=|300−200|−|250−150|−0=0.

It is, therefore, proved that the number of frame losses between MEP#A and MIP#1 is zero, that is, no loss occurs.

(Frame Loss Determination at MIP#2)

Details of frame loss determination at MIP#2 in the cycle T=3 are described below.

On receiving the LMM frame from MEP#A, MIP#2 obtains the transmission counter value of MEP#A (TxMEP#A) in the current cycle T=3, that is TxFCf(t)=300, from the storage information in the received LMM frame. At the same time, MIP#2 obtains Σ Loss (t)=0 (the total number of losses between MEP#A and the preceding MIP) from the LMM frame.

Next, MIP#2 obtains the transmission counter value of MEP#A (TxMEP#A) in the preceding cycle T=2, that is TxFCf(t−1)=200, from the LM counter table 32. At the same time, MIP#2 obtains the reception counter value of MIP#2 (RxMIP#2) in the preceding cycle T=2, that is RxFCf_mip(t−1)=150, from the LM counter table 32.

MIP#2 obtains the reception counter value of MIP#2 in the current cycle T=3, that is RxFCf_mip(t)=240, from the counter table 22.

Next, the number of frame losses between MEP#A and MIP#1 which is calculated by the formula (4) is as follows,

|TxMEP#A(t)−TxMEP#A(t−1)|−|RxMIP#2(t)−RxMIP#2(t−1)|−ΣLoss(t)=|300−200|−|240−150|−0=10.

It is, therefore, proved that the frame loss occurs between MIP#1 and MIP#2, and the number of losses is 10.

Finally, MIP#2 stores MIP-ID thereof and the number of losses into the LMM frame and transmits the LMM frame to the next apparatus (MIP#3), when a loss occurs in the MIP#2.

(Frame loss determination at MIP#3)

Details of frame loss determination at MIP#3 in the cycle T=3 are described below.

On receiving the LMM frame from MIP#2, MIP#3 obtains the transmission counter value of MEP#A (TxMEP#A) in the current cycle T=3, that is TxFCf(t)=300, from the storage information in the received LMM frame. At the same time, MIP#3 obtains ΣLoss (t)=10 (the total number of losses between MEP#A and the preceding MIP) from the LMM frame.

The value of Σ Loss (t) is 10, because the frame losses in which the number of losses is 10 occur between MIP#1 and MIP#2, and MIP#2 stores the number of losses in the LMM frame.

Next, MIP#3 obtains the transmission counter value of MEP#A (TxMEP#A) in the preceding cycle T=2, that is TxFCf(t−1)=200, from the LM counter table 32. At the same time, MIP#3 obtains the reception counter value of MIP#3 (RxMIP#3) in the preceding cycle T=2, that is RxFCf_mip(t−1)=150, from the LM counter table 32.

MIP#3 obtains the reception counter value of MIP#3 in the current cycle T=3, that is RxFCf_mip(t)=210, from the counter table 22.

Next, the number of frame losses between MIP#2 and MIP#3 which is calculated by the formula (4) is as follows,

|TxMEP#A(t)−TxMEP#A(t−1)|−|RxMIP#3(t)−RxMIP#3(t−1)|−ΣLoss(t)=|300−200|−|210−150|−10=30.

It is, therefore, proved that the frame loss occurs between MIP#2 and MIP#3 and the number of losses is 30.

Finally, MIP#3 stores MIP-ID thereof and the number of losses into the LMM frame and transmits the LMM frame to the next apparatus (MEP#B), when a loss occurs in the MIP#3.

(Frame Loss Determination at MEP#B)

Details of frame loss determination at MEP#B in the cycle T=3 are described below.

On receiving the LMM frame from MIP#3, MEP#B obtains the transmission counter value of MEP#A (TxMEP#A) in the current cycle T=3, that is TxFCf(t)=300, from the storage information in the received LMM frame. At the same time, MEP#B obtains ΣLoss (t)=40 (the number of losses between MEP#A and the preceding MIP) from the LMM frame.

The value of Σ Loss (t) is 40 here. Because the frame losses in which the number of losses is 10 occur in the section of MIP#1 -MIP#2 and the frame losses in which the number of losses is 30 occur in the section of MIP#2-MIP#3, the total number of losses is 40.

Next, MEP#B obtains the transmission counter value of MEP#A (TxMEP#A) in the preceding cycle T=2, that is TxFCf(t−1)=200, from the LM counter table 32. At the same time, MEP#B obtains the reception counter value of MEP#B (RxMEP#B) in the preceding cycle T=2, that is RxFCf_mip(t−1)=150, from the LM counter table 32.

MEP#B obtains the reception counter value of MEP#B in the current cycle T=3, that is RxFCf_mip(t)=210, from the counter table 22.

Next, the number of frame losses between MIP#3 and MEP#B which is calculated by the formula (4) is as follows,

|TxMEP#A(t)−TxMEP#A(t−1)|−|RxMEP#B(t)−RxMEP#B(t−1)|−ΣLoss(t)=|300−200|−|210−150|−40=0.

It is, therefore, proved that the number of frame losses between MIP#3 and MEP#B is zero, that is, no loss occurs.

(Frame Loss Measurement at Source MEP#A)

When the LMM frame reaches MEP#B, MEP#B transmits the LMR frame toward MEP#A as described in the first exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (1), the following formula is obtained,

Loss(far-end)=|TxFCf(t)−TxFCf(t−1)|−|RxFCf(t)−RxFCf(t−1)|=|300−200 |−210−150|=40.

Therefore, it is proved that the number of frame losses of the end-to-end, that is, between MEP#A and MEP#B, is 40.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 15, MIP#2 and MIP#3 are stored in the LMR frame as the frame loss occurrence MIP-ID, and the number of losses of them are 10 and 30, respectively. Accordingly, it can be identified that 10 frame losses occur between MIP#1 and MIP#2 and 30 frame losses occur between MIP#2 and MIP#3.

### <Example of Operations (2)>

In the example of operations (1), the case in which the LMM frame is transmitted from MEP#A to MEP#B is described, and descriptions on the LMR frame is omitted. In this example of operations, operations, which are executed when the LMR frame is transmitted from MEP#B to MEP#A in the first exemplary embodiment, are described by using the numerical example. The operations differ in the frame transmitting direction from that of the LMM frame. The formula for the frame loss measurement is not changed.

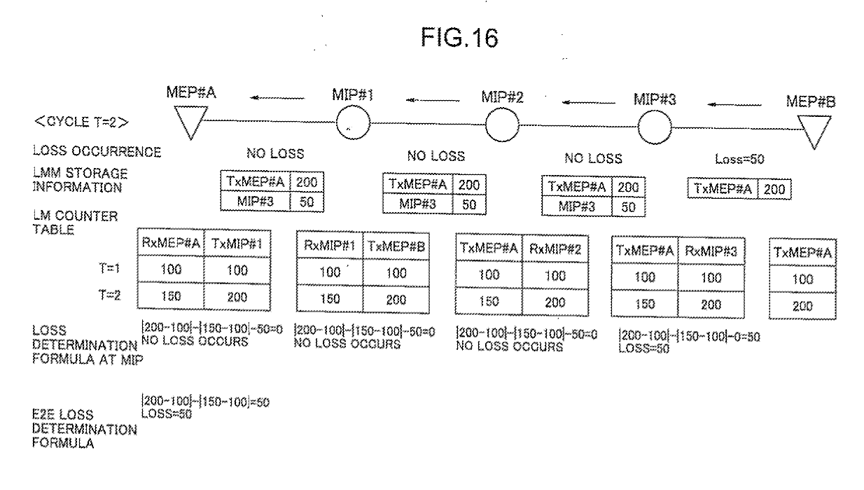

FIG. 16 illustrates information transition which occurs when MEP#B receiving the LMM frame transmits the LMR frame as a reply thereof toward MEP#A and the LMR frame passes through each MEP/MIP, at the time of executing LM on the network in FIG. 1. Specifically, calculations of the counter value stored in the LMR frame, the information on the number of losses, the storage information in the LM counter table 32 at each MEP/MIP, and frame loss determination at each MEP/MIP are illustrated.

FIG. 16 shows a condition in the current cycles T=2. Numerical values at the time of executing LM in the cycles T=1, 2 are stored in each table. The source MEP#B transmits 100 frames in each cycle. Losses of 50 frames occur between MEP#B and MIP#3 in the cycle T=2. In the cycle T=1, each MEP/MIP stores the same information as the case of the cycle T=1 in FIG. 14. For simplification, operations in the cycle T=2 are described here. The information of only the near-end direction (direction from MEP#B to MEP#A) is described.

(Frame loss determination at MIP#3)

Details of frame loss determination at MIP#3 in the cycle T=2 are described below.

On receiving the LMR frame from MEP#B, MIP#3 obtains the transmission counter value of MEP#B (TxMEP#B) in the current cycle T=2, that is TxFCb(t)=200, from the storage information in the received LMR frame. At the same time, MIP#3 obtains ΣLoss (t)=0 (the total number of losses between MEP#B and the preceding MIP) from the LMR frame.

Next, MIP#3 obtains the transmission counter value of MEP#B (TxMEP#B) in the preceding cycle T=1, that is TxFCb(t−1)=100, from the LM counter table 32. At the same time, MIP#3 obtains the reception counter value of MIP#3 (RxMIP#3) in the preceding cycle T=1, that is RxFCb_mip(t−1)=100, from the LM counter table 32.

MIP#3 obtains the reception counter value of MIP#3 in the current cycle T=2, that is RxFCb_mip(t)=150, from the counter table 22.

Next, the number of frame losses between MEP#B and MIP#3 which is calculated by the formula (4) is as follows,

|TxMEP#B(t)−TxMEP#B(t−1)|−|RxMIP#3(t)−RxMIP#3(t−1)|−ΣLoss(t)=|200−100|−|150−100|−0=50.

It is, therefore, proved that the frame losses occur between MEP#B and MIP#3, and the number of frame losses is 50.

Finally, MIP#3 stores MIP-ID thereof and the number of losses in the LMR frame, and transmits the LMR frame to the next apparatus (MIP#2), when a loss occurs in the MIP#3.

(Frame loss determination at MIP#2)

Details of frame loss determination at MIP#2 in the cycle T=2 are described below.

On receiving the LMR frame from MIP#3, MIP#2 obtains the transmission counter value of MEP#B (TxMEP#B) in the current cycle T=2, that is TxFCb(t)=200, from the storage information in the received LMR frame. At the same time, MIP#2 obtains ΣLoss (t)=50 (the number of losses between MEP#B and the preceding MIP) from the LMR frame.

The value of ΣLoss (t) is 50, because the frame loss in which the number of losses is 50 occurs between MEP#B and MIP#3, and MIP#3 stores the number of losses in the LMR frame.

Next, MIP#2 obtains the transmission counter value of MEP#B (TxMEP#B) in the preceding cycle T=1, that is TxFCb(t−1)=100, from the LM counter table 32. At the same time, MIP#2 obtains the reception counter value of MIP#2 (RxMIP#2) in the preceding cycle T=1, that is RxFCb_mip(t−1)=100, from the LM counter table 32.

MIP#2 obtains the reception counter value of MIP#2 in the current cycle T=2, that is RxFCb_mip(t)=150, from the counter table 22.

Next, the number of frame losses between MIP#3 and MIP#2 which is calculated by the formula (4) is as follows,

|TxMEP#B(t)−TxMEP#B(t−1)|−|RxMIP#2(t)−RxMIP#2(t−1)|−ΣLoss(t)=|200−100|−|150−100|−50=0.

It is proved that the number of frame losses between MIP#3 and MIP#2 is zero, that is, no loss occurs.

(Frame Loss Determination at MIP#1)

Details of frame loss determination at MIP#1 in the cycle T=2 are described below.

On receiving the LMR frame from MIP#2, MIP#1 obtains the transmission counter value of MEP#B (TxMEP#B) in the current cycle T=2, that is TxFCb(t)=200, from the storage information in the received LMR frame. At the same time, MIP#1 obtains Σ Loss (t)=50 (the number of losses between MEP#B and the preceding MIP) from the LMR frame.

The value of ΣLoss (t) is 50, because the frame loss in which the number of losses is 50 between MEP#B and MIP#3, and MIP#3 stores the number of losses in the LMR frame.

Next, MIP#1 obtains the transmission counter value of MEP#B (TxMEP#B) in the preceding cycle T=1, that is TxFCb(t−1)=100, from the LM counter table 32. At the same time, MIP#1 obtains the reception counter value of MIP#1 (RxMIP#1) in the preceding cycle T=1, that is RxFCb_mip(t−1)=100, from the LM counter table 32.

MIP#1 obtains the reception counter value of MIP#1 in the current cycle T=2, that is RxFCb_mip(t)=150, from the counter table 22.

Next, the number of frame losses between MIP#2 and MIP#1 which is calculated by the formula (4) is as follows,

|TxMEP#B(t)−TxMEP#B(t−1)|−|RxMIP#1(t)−RxMIP#1(t−1)|−ΣLoss(t)=|200−100|−|150−100|−50=0.

It is, therefore, proved that the number of frame losses between MIP#2 and MIP#1 is zero, that is, no frame loss occurs.

(Frame Loss Determination at MEP#A)

Details of frame loss determination at MEP#A in the cycle T=2 are described below.

On receiving the LMR frame from MIP#1, MEP#A obtains the transmission counter value of MEP#B (TxMEP#B) in the current cycle T=2, that is TxFCb(t)=200, from the storage information in the received LMR frame. At the same time, MEP#A obtains ΣLoss (t)=50 (the number of losses between MEP#B and the preceding MIP) from the LMR frame.

The value of ΣLoss (t) is 50, because the frame loss in which the number of losses is 50 between MEP#B and MIP#3 occurs, and MIP#3 stores the number of losses in the LMR frame.

Next, MEP#A obtains the transmission counter value of MEP#B (TxMEP#B) in the preceding cycle T=1, that is TxFCb(t−1)=100, from the LM counter table 32. At the same time, MEP#A obtains the reception counter value of MEP#A (RxMEP#A) in the preceding cycle T=1, that is RxFCb_mip(t−1)=100, from the LM counter table 32.

MEP#A obtains the reception counter value of MEP#A in the current cycle T=2, that is RxFCb_mip(t)=150, from the counter table 22.

Next, the number of frame losses between MIP#1 and MEP#A which is calculated by the formula (4) is as follows,

|TxMEP#B(t)−TxMEP#B(t−1)|−|RxMIP#A(t)−RxMIP#A(t−1)|−ΣLoss(t)=|200−100|−|150−100|−50=0.

It is, therefore, proved that the number of frame losses between MIP#1 and MEP#A is zero, that is, no frame loss occurs.

(Frame Loss Measurement at MEP#A)

Frame loss measurement which is executed when the LMR frame reaches MEP#A is described below.

MEP#A measures the end-to-end frame loss. By using the formula (1), the following formula is obtained,

Loss(near-end)=|TxFCb(t)−TxFCb(t−1)|−|RxFCb(t)−RxFCb(t−1)|=|200−100|−|150−100|=50.

Therefore, it is proved that the number of frame losses of the end-to-end, that is, between MEP#A and MEP#B, is 50.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 16, MIP#2 is stored in the LMR frame as the frame loss occurrence MIP-ID, and the number of losses thereof is 50. Accordingly, it can be identified that 50 frame losses occur between MEP#B and MIP#3.

### Second Exemplary Embodiment

A second exemplary embodiment of the invention is described in detail by using drawings. An entire configuration of a system is similar to that of the first exemplary embodiment (FIG. 1). An OAM control unit is changed compared with the communication apparatuses 1 to 5 (FIG. 2) of the first exemplary embodiment. An OAM control unit 153 is described below. The other elements are the same as these of the first exemplary embodiment, and detailed descriptions thereof are omitted.

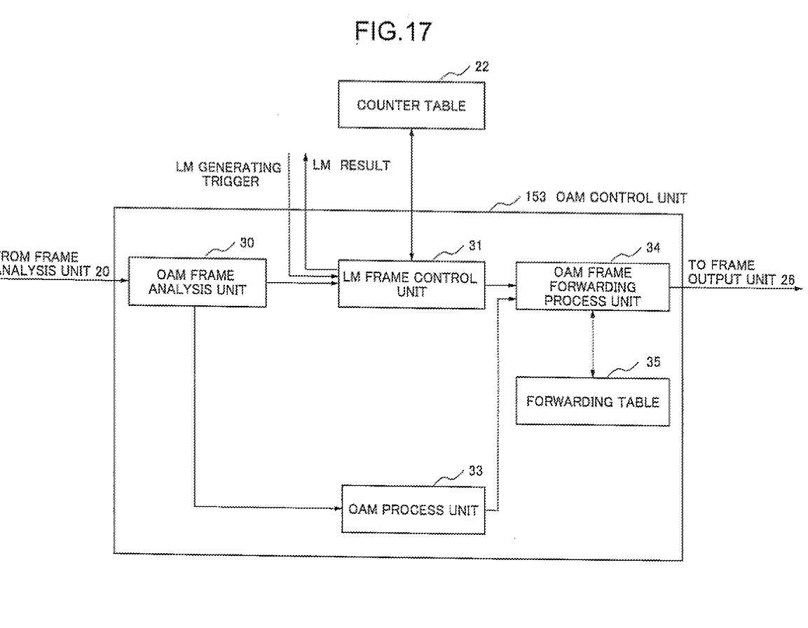

FIG. 17 is a block diagram illustrating a configuration of the OAM control unit 153 of the exemplary embodiment. The second exemplary embodiment lacks the LM counter table 32 compared with the OAM control unit 23 of the first exemplary embodiment. The other elements are similar to these of the first exemplary embodiment (FIG. 3). Operations of the LM frame control unit 31 are, however, different from these of the first exemplary embodiment. The operations of the second exemplary embodiment are described below centering on the operations of the LM frame control unit 31.

Initially, a calculating method for the frame loss is described.

In the first exemplary embodiment, the transmission counter value of the source MEP in the preceding cycle and the history of the reception counter value of the MEP/MIP itself have to be held in order to determine whether or not the frame loss occurs at each MEP/MIP.

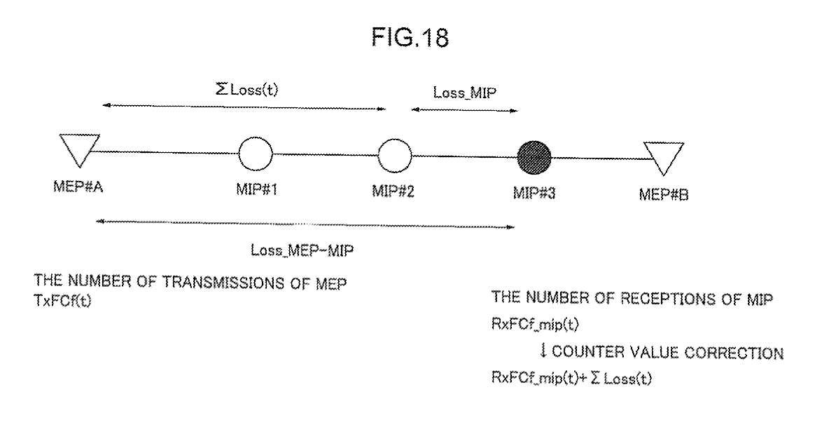

FIG. 18 illustrates an outline of the second exemplary embodiment. In the second exemplary embodiment, when the frame loss is detected, each of local counter values is corrected at each MEP/MIP. When the correction is executed, it becomes possible to eliminate impact on deviation of the next cycle counter value caused by an occurred frame loss and it becomes unnecessary to hold the history of the counter values. Specifically, the number of frame losses is added to the local counter value when the frame loss is detected, and the transmission counter value of the source MEP is restored.

By using the corrected local counter value (RxFCf_mip(t) or RxFCb_mip(t)), The number of frame losses of the far-end direction and the near-end direction at each MIP is given by the following formulae,

Far-end direction: Loss_MIP=TxFCb(t)−RxFCf_mip(t)−ΣLoss(t) formula (6)

Near-end direction: Loss_MIP=TxFCb(t)−RxFCb_mip(t)−ΣLoss′(t) formula (7).

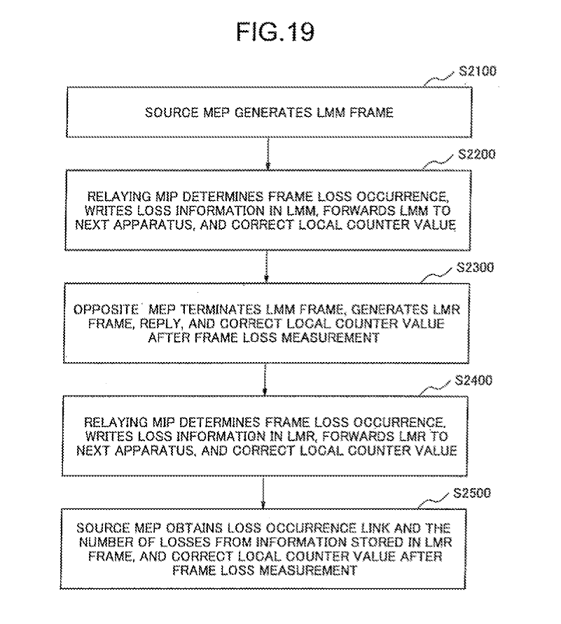

Operations above are described in detail. FIG. 19 is a flowchart illustrating the entire operations of the exemplary embodiment.

In step S2100, the source MEP#A generates the LMM frame and forwards it to the next apparatus (MIP#1).

In step S2200, relaying MIP#1, MIP#2 and MIP#3 determines whether or not the frame loss occurs, on receiving the LMM frame. If occurrence of the frame loss is determined, information on the number of frame losses is stored in the LMM frame and the LMM frame is forwarded to the next apparatus (MIP#2, MIP#3, MEP#B). After the frame loss calculation, the local counter value is changed to the transmission counter value of the source MEP#A stored in the LMM frame.

In step S2300, the opposite MEP#B terminates the LMM frame, generates the LMR frame based on the information in the LMM frame, and forwards the LMR frame to the next apparatus (MIP#3). After the reception counter value is referred to, the local counter value is changed into the transmission counter value of the source MEP#A, like step S2200.

In step S2400, relaying MIP#3, MIP#2 and MIP#1 determine whether or not the frame loss occurs, on receiving the LMR frame. If the frame loss occurs, the information on the number of frame losses is stored in the LMR frame and the LMR frame is forwarded to the next apparatus (MIP#2, MIP#1, MEP#A). After the frame loss calculation, the local counter value is changed into the transmission counter value of the source MEP#B. Finally, in step S2500, on receiving the LMR frame, the source MEP#A calculates the number of end-to-end frame losses and the number of frame losses in each section based on the information stored in the LMR frame. After the frame loss calculation, the local counter value is changed into the transmission counter value of the source MEP#B.

Detailed operations of each of the steps are described below by using flowcharts illustrated in FIG. 19 to FIG. 23. Descriptions on the operation in step S2100, which is similar to that of the first exemplary embodiment, are omitted.

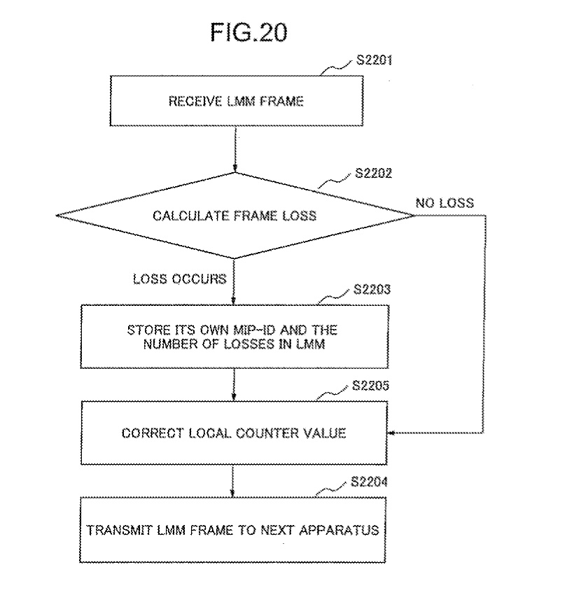

FIG. 20 illustrates detailed operation flow in step S2200 of FIG. 19. In step S2201, initially the LM frame control unit 31 receives the LMM frame from the OAM frame analysis unit 30.

In step S2202, the LM frame control unit 31 calculates the frame loss. The deriving formula for the frame loss calculation is the formula (6).

The LM frame control unit 31 obtains parameters which are necessary for calculation of the formula (6), from the followings,

TxFCf(t): from the received LMM frame,

RxFCf_mip(t): by referring to the counter table 22,

ΣLoss (t): from the received LMM frame.

A frame format of the LM frame is similar to that of the first exemplary embodiment (FIG. 13).

In the frame loss calculation in step S2202, step S2203 is executed when the frame loss is detected.

In step S2203, the LM frame control unit 31 writes its own MIP-ID and the number of frame losses into the LMM frame, and forwards the LMM frame to the OAM frame forwarding process unit 34.

In step S2205, the LM frame control unit 31 changes the local counter value of the counter table into the transmission counter (TxFCf) value of the source MEP#A.

In step S2204, the OAM frame forwarding process unit 34 refers to the forwarding table 35 and determines the output port. After that, the OAM frame forwarding process unit 34 forwards the LMM frame to the frame output unit 26. The frame output unit 26 forwards the LMR frame to the next apparatus. In step S2202, step S2205 is directly executed when no frame loss is detected.

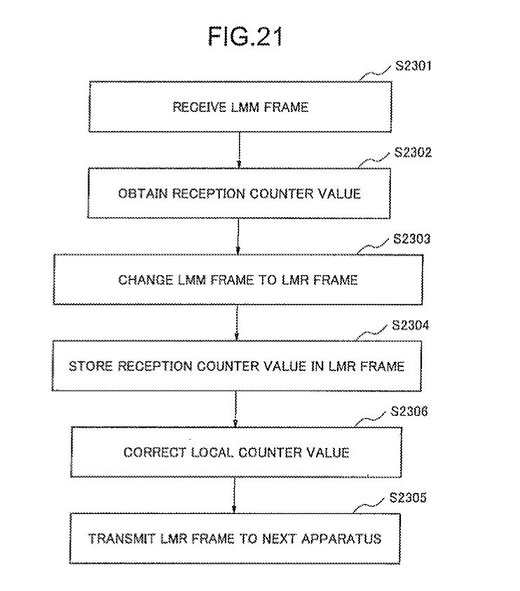

FIG. 21 is a flowchart illustrating detailed operations in step S2300 of FIG. 19.

In step S2301, the LM frame control unit 31 receives the LMM frame from the OAM frame analysis unit 30. Next, in step S2302, the reception counter value RxFCf(t) is obtained by referring to the counter table 22. In step S2303, the LM frame control unit 31 terminates the LMM frame and generates the LMR frame using the information in the LMM frame.

In step S2304, the LM frame control unit 31 stores the reception counter value RxFCf(t) obtained in step S3-2 in the generated LMR frame and forwards the LMR frame to the OAM frame forwarding process unit 34. In step S2306, the LM frame control unit 31 changes the local counter value in the counter table 22 into the transmission counter (TxFCf) value of the source MEP#A. In step S2305, the OAM frame forwarding process unit 34 determines the output port by referring to the forwarding table 37. After that, the OAM frame forwarding process unit 34 forwards the LMR frame to the frame output unit 26. The frame output unit 26 forward the LMR frame to the next apparatus.

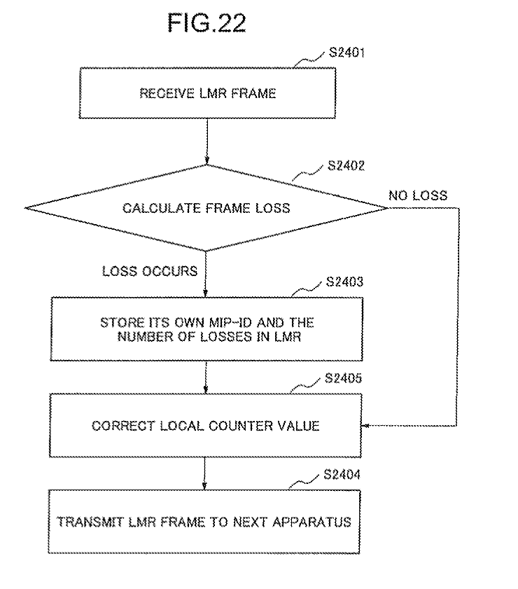

Next, detailed operations in step S2400 of FIG. 19 are described. FIG. 22 is a flowchart illustrating detailed operations in step S2400 of FIG. 19.

In step S2401, the LM frame control unit 31 receives the LMR frame from the OAM frame analysis unit 30. Next, in step S2402, frame loss calculation is executed. A deriving formula used in the frame loss calculation is the formula (7) of the near-end direction.

The LM frame control unit 31 obtains parameters which are necessary for calculation of the formula (4), from the followings,

TxFCb(t): from the received LMR frame,

RxFCb_mip(t): by referring to the counter table 22,

ΣLoss′ (t): from the received LMR frame.

In the frame loss calculation in step S2402, step S2403 is executed when the frame loss is detected.

In step S2403, the LM frame control unit 31 writes MIP-ID of the apparatus and the number of frame losses into the LMR frame, and forwards the LMR frame to the OAM frame forwarding process unit 34.

In step S2405, the LM frame control unit 31 changes the local counter value of the counter table 22 into the transmission counter (TxFCf) value of the source MEP#B.

In step S2404, the OAM frame forwarding process unit 34 refers to the forwarding table 35 and determines the output port. After that, the frame output unit 26 forwards the LMR frame to the next apparatus.

In step S2402, correction of the local counter value of step S2405 is directly executed when no frame loss is detected.

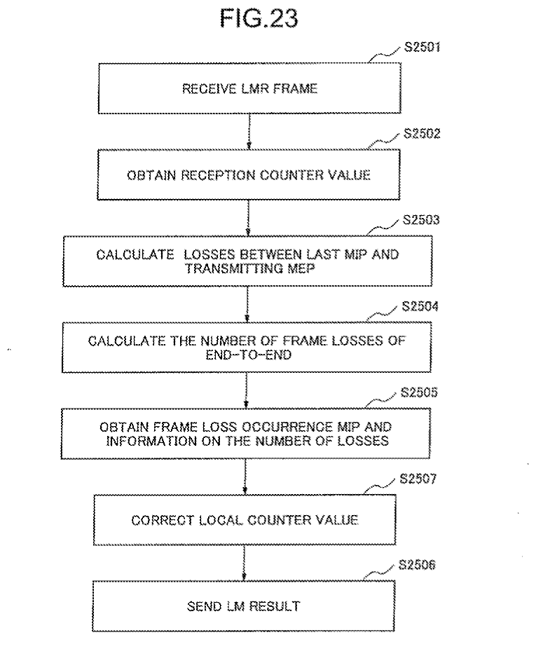

Finally, detailed operations of step S2500 of FIG. 19 are described. FIG. 23 is a flowchart illustrating detailed operations in step S2500 of FIG. 19.

In step S2501, the LM frame control unit 31 receives the LMR frame from the OAM frame analysis unit 30. Next, in step S2502, the reception counter value RxFCb(t) is obtained by referring to the counter table 22. In step S2503, the LM frame control unit 31 calculates the number of frame losses which occur between the MIP which the LMR frame finally passes through and the source MEP (between MIP#1 and MEP#A) by using the formula (7).

In step S2504, the LM frame control unit 31 calculates the frame loss of the end-to-end of the far-end direction and the near-end direction by using following formulae (8) and (9),

Loss(far-end)=TxFCf(t)−RxFCf(t) formula (8)

Loss(near-end)=TxFCb(t)−RxFCb(t) formula (9).

Next, in step S2505, the LM frame control unit 31 obtains the information on MIP-ID which generates the frame loss and the number of losses from the information stored in the LMR frame. The order of step S2504 and step S2505 may be reversed.

In step S2507, the LM frame control unit 31 changes the local counter value of the counter table 22 into the transmission counter (TxFCb) value of the source MEP#A.

Finally, in step S2506, the end-to-end frame loss information and the frame loss information in each section, which are results of LM, are outputted to the outside (memory, external output interface, and the like).

The management unit MEP#A can measure the number of frame losses of the end-to-end and the frame loss information in each section based on the above operations from step S2100 to step S2500.

In the second exemplary embodiment, in step S2200 and step S2400, frame loss occurrence can be detected from the transmission counter value of the source MEP and the reception counter value of the MIP itself, and the MIP-ID information and the information on the number of losses are transmitted when the loss occurs. Since two pieces of the information are not written when no frame loss occurs, a frame size can be decreased and band efficiency can be enhanced.

Additionally, in step S2200 and step S2400, the frame loss occurring MIP calculates and transmits the number of frame losses. Therefore, in step S2500, referring to the stored information in the LMR frame and calculating the frame loss between the last MIP where the LMR passes through and the source MEP, the source MEP can obtain the frame loss occurring M IP and the information on the number of losses. Therefore, amount of calculation at each MEP/MIP can be reduced.

The second exemplary embodiment differs from the first exemplary embodiment in that the frame loss occurring MIP corrects the local counter value of the MIP. It, therefore, becomes possible to calculate the frame loss by using only the counter value in the current cycle in each MEP/MIP. Accordingly, it is not necessary to hold the history information in the preceding cycle of the transmission counter value of the source MEP/the reception counter value of the MIP itself.

### <Example of Operations (3)>

Operations of the second exemplary embodiment are described below by using specific numerical examples.

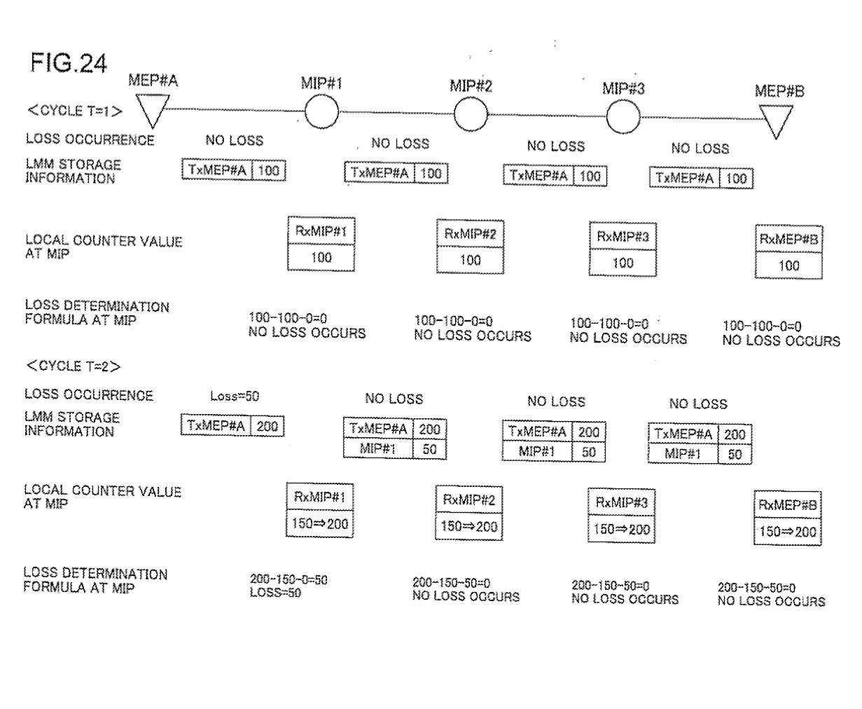

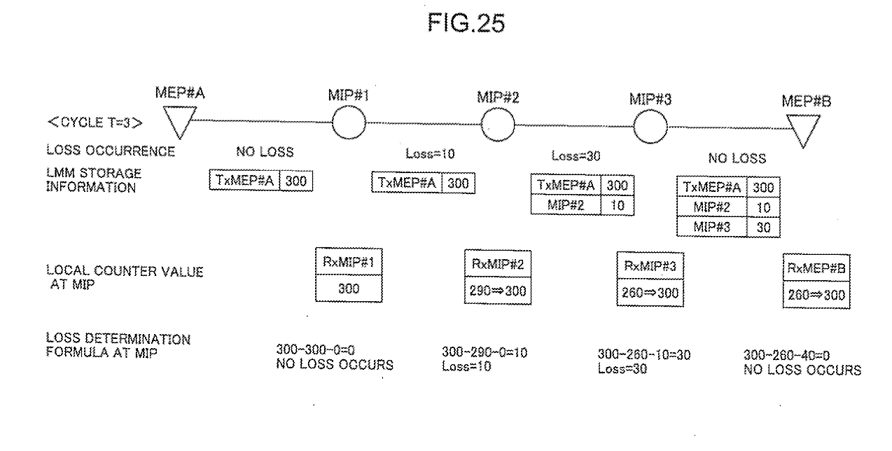

FIG. 24 and FIG. 25 illustrate calculations of the counter value stored in the LMM frame at the time of executing LM on the network in FIG. 1, the information on the number of losses, the storage information in the LM counter table 32 at each MEP/MIP, and frame loss determination at each MEP/MIP. In FIG. 24, an example of the far-end direction is only described, for simplification. Additionally, it is supposed that a new frame loss does not occur in the near-end direction.

FIG. 24 shows numerical examples in the cycles T=1, 2. FIG. 25 shows numeric values of T=3 at the time of executing LM, as an example in which frame losses occur in a plurality of sections.

The source MEP#A transmits 100 frames in each cycle. Losses of 50 frames occur between MEP#A and MIP#1 in the cycle T=2. Losses of 10 frames occur between MIP#1 and MIP#2 and losses of 30 frames occur between MIP#2 and MIP#3, in the cycle T=3.

Storage information in the LMM frame in each cycle, and transition of conditions in the LM counter table and frame loss measurement at each MEP/MIP is described in detail, by using numerical examples.

### <Cycle T=1>

### (Frame Loss Determination at MIP#1)

Details of frame loss determination at MIP#1 in the cycle T=1 are described below. On receiving the LMM frame from MEP#1, MIP#1 obtains the transmission counter value of MEP#A (TxMEP#A) in the current cycle T=1, that is TxFCf(t)=100, from the storage information in the received LMM frame. At the same time, MIP#1 obtains Σ Loss (t)=0 (the number of losses between MEP#A and the preceding MIP) from the LMM frame.

Next, MIP#1 obtains the reception counter value RxFCf_mip(t)=100 in the current cycle T=1 from the counter table 22.

Next, the number of frame losses between MEP#A and MIP#1 which is calculated by the formula (6) is as follows,

TxMEP#A(t)−RxMIP#1(t)−ΣLoss(t)=100−100=0.

It is proved that the number of frame losses between MEP#A and MIP#1 is zero, that is, no loss occurs.

Finally, MIP#1 changes the reception counter value into “100” that is the transmission counter value of the source MEP#A, and completes the frame loss determination at MIP#1. In this case, since no frame loss occurs, the reception counter value is “100” after changing in the same way as before changing.

(Frame Loss Determination at MIP#2, MIP#3 and MEP#B)

Conditions in frame loss determination at MIP#2, MIP#3 and MEP#B are similar to that of MIP#1, since no frame loss occurs in any section. Therefore, descriptions on the frame loss determination at MIP#2, MIP#3 and MEP#B are omitted.

### (Frame Loss Determination at Source MEP#A)

When the LMM frame reaches MEP#B, MEP#B transmits the LMR frame toward MEP#A as described in the second exemplary embodiment. Descriptions on performances which are executed when the LMR frame reaches each MEP/MIP are omitted, and frame loss is measurement which is executed when the LMR frame reaches MEP#A is described below.

MEP#A measures the end-to-end frame loss. By using the formula (8), the following formula is obtained,

Loss(far-end)=TxFCf(t)−RxFCf(t)=100−100=0.

Next, the number of frame losses is measured in each section. Since the frame loss occurrence MIP-ID is not written in the LMR frame received by MEP#A (or since no loss occurs over the end-to-end), it is determined that no loss occurs in any section.

### <Cycle T=2>

A numerical example of frame loss determination at each MEP/MIP in the cycle T=2 is described. In the cycle T=2, the frame loss occurs in the section of MEP#A-MIP#1, and the number of the losses is 50.

### (Frame Loss Determination at MIP#1)

Details of frame loss determination at MIP#1 in the cycle T=2 are described below.

On receiving the LMM frame from MEP#A, MIP#1 obtains the transmission counter value of MEP#A (TxMEP#A) in the current cycle T=2, that is TxFCf(t)=200, from the storage information in the received LMM frame. At the same time, MIP#1 obtains Σ Loss (t)=0 (the number of losses between MEP#A and the preceding MIP) from the LMM frame.

Next, MIP#1 obtains the reception counter value of MIP#1 (RxMIP#1), that is RxFCf mip(t)=150, in the current cycle T=2 from the counter table 22.

Next, the number of frame losses between MEP#A and MIP#1 which is calculated by the formula (6) is as follows,

TxMEP#A(t)−RxMIP#1(t)−ΣLoss(t)=200−150−0=50.

It is proved that the frame loss occurs between MEP#A and MIP#1 and the number of losses is 50.

MIP#1 changes the reception counter value “150” into “200” that is the transmission counter value of the source MEP#A, and completes the frame loss determination at MIP#1.

Finally, MIP#1 stores its own MIP-ID and the number of losses into the LMM frame and transmits the LMM frame to the next apparatus (MIP#2), responding to loss occurrence at the MIP#1.

### (Frame Loss Determination at MIP#2)

Details of frame loss determination at MIP#2 in the cycle T=2 are described below.

On receiving the LMM frame from MIP#1, MIP#2 obtains the transmission counter value of MEP#A (TxMEP#A) in the current cycle T=2, that is TxFCf(t)=200, from the storage information in the received LMM frame. At the same time, MIP#2 obtains ΣLoss (t)=50 (the number of losses between MEP#A and the preceding MIP) from the LMM frame.

Next, MIP#2 obtains the reception counter value of MIP#2, that is RxFCf_mip(t)=150, in the current cycle T=2 from the counter table 22.

Next, the number of frame losses between MIP#1 and MIP#2 which is calculated by the formula (6) is as follows,

TxMEP#A(t)−RxMIP#2(t)−ΣLoss(t)=200−150−50=0.

It is proved that the number of frame losses between MIP#1 and MIP#2 is zero, and no frame loss occurs in the section.

Finally, MIP#2 changes the reception counter value “150” into “200” that is the transmission counter value of the source MEP#A, and completes the frame loss determination at MIP#2.

(Frame Loss Determination at MIP#3 and MEP#B)

Conditions in frame loss determination at MIP#3 and MEP#B are similar to that of MIP#2, since no frame loss occurs in any sections related to MIP#3 and MEP#B. Therefore, descriptions on the frame loss determination at MIP#3 and MEP#B are omitted.

(Frame loss measurement at source MEP#A)

When the LMM frame reaches MEP#B, MEP#B transmits the LMR frame toward MEP#A as described in the second exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (8), the following formula is obtained,

Loss(far-end)=TxFCf(t)−RxFCf(t)=200−150=50.

Therefore, it is proved that the number of frame losses of the end-to-end, that is, between MEP#A and MEP#B, is 50.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 24, MIP#1 is stored in the LMR frame as the frame loss occurrence MIP-ID, and the number of losses is 50. Accordingly, it is identified that 50 frame losses occur between MEP#A and MIP#1.

### <Cycle T=3>

A numerical example of frame loss determination at each MEP/MIP in cycle T=3 is described. In the cycle T=3, the frame losses occur in the sections of MIP#1-MIP#2 and MIP#2-MIP#3, and the number of the losses in the sections are 10, and 30, respectively.

(Frame loss determination at MIP#1)

Details of frame loss determination at MIP#1 in the cycle T=3 are described below. On receiving the LMM frame from MEP#1, MIP#1 obtains the transmission counter value of MEP#A (TxMEP#A) in the current cycle T=3, that is TxFcf(t)=300, from the storage information in the received LMM frame. At the same time, MIP#1 obtains ΣLoss (t)=0 (the number of losses between MEP#A and the preceding MIP) from the LMM frame.

Next, MIP#1 obtains the reception counter value RxFCf_mip(t)=300 in the current cycle T=3 from the counter table 22.

Next, the number of frame losses between MEP#A and MIP#1 which is calculated by the formula (6) is as follows,

TxMEP#A(t)−RxMIP#1(t)−ΣLoss(t)=300−300=0.

It is proved that the frame loss between MEP#A and MIP#1 is zero, and no frame loss occurs.

Finally, MIP#1 changes the reception counter value into “300” that is the transmission counter value of the source MEP#A, and completes the frame loss determination at MIP#1. En this case, since no frame loss occurs, the reception counter value is “300” after changing in the same way as before changing.

(Frame Loss Determination at MIP#2)

Details of frame loss determination at MIP#2 in the cycle T=3 are described below.

On receiving the LMM frame from MIP#1, MIP#2 obtains the transmission counter value of MEP#A (TxMEP#A) in the current cycle T=3, that is TxFCf(t)=300, from the storage information in the received LMM frame. At the same time, MIP#2 obtains ΣLoss (t)=0 (the number of losses between MEP#A and the preceding MIP#1) from the LMM frame.

Next, MIP#2 obtains the reception counter value of MIP#2, that is RxFCf_mip(t)=240, in the current cycle T=3 from the counter table 22.

Next, the number of frame losses between MEP#A and MIP#1 which is calculated by the formula (6) is as follows,

TxMEP#A(t)−RxMIP#2(t)−ΣLoss(t)=300−290−0=10.

It is proved that the frame loss occurs between MIP#1 and MIP#2, and the number of the losses is 10.

MIP#2 changes the reception counter value “290” into “300” that is the transmission counter value of the source MEP#A, and completes the frame loss determination at MIP#2.

Finally, MIP#2 stores its own MIP-ID and the number of losses into the LMM frame and transmits the LMM frame to the next apparatus (MIP#3), responding to loss occurrence at the MIP#2.

(Frame loss determination at MIP#3)

Details of frame loss determination at MIP#3 in the cycle T=3 are described below.

On receiving the LMM frame from MIP#2, MIP#3 obtains the transmission counter value of MEP#A (TxMEP#A) in the current cycle T=3, that is TxFCf(t)=300, from the storage information in the received LMM frame. At the same time, MIP#3 obtains ΣLoss (t)=10 (the total number of losses between MEP#A and the preceding MIP) from the LMM frame. The value of ΣLoss (t) is 10, because the frame losses in which the number of losses is 10 occur between MIP#1 and MIP#2, and MIP#2 stores the number of losses in the LMM frame.

Next, MIP#3 obtains the reception counter value of MIP#3, that is RxFCf_mip(t)=260, in the current cycle T=3 from the counter table 22.

Next, the number of frame losses between MIP#2 and MIP#3 which is calculated by the formula (6) is as follows,

TxMEP#A(t)−RxMIP#3(t)−ΣLoss(t)=300−260−10=30.

It is proved that the frame loss occurs between MIP#2 and MIP#3, and the number of the losses is 30.

MIP#3 changes the reception counter value “260” into “300” that is the transmission counter value of the source MEP#A, and completes the frame loss determination at MIP#3.

Finally, MIP#3 stores its own MIP-ID and the number of losses into the LMM frame and transmits the LMM frame to the next apparatus (MEP#B), responding to loss occurrence at the MIP#3.

(Frame Loss Determination at MEP#B)

Details of frame loss determination at MEP#B in the cycle T=3 are described below.

On receiving the LMM frame from MIP#3, MEP#B obtains the transmission counter value of MEP#A (TxMEP#A) in the current cycle T=3, that is TxFCf(t)=300, from the storage information in the received LMM frame. At the same time, MEP#B obtains ΣLoss (t)=40 (the number of losses between MEP#A and the preceding MIP) from the LMM frame.

The value of ΣLoss (t) is 40 here, because the frame losses in which the number of losses is 10 occur in the section of MIP#1-MIP#2, and the frame losses in which the number of losses is 30 occur in the section of MIP#2-MIP#3, and the total number of frame losses is 40.

MEP#B obtains the reception counter value of MEP#B in the current cycle T=3, that is RxFCf_mip(t)=260, from the counter table 22.

Next, the number of frame losses between MIP#3 and MEP#B which is calculated by the formula (6) is as follows,

TxMEP#A(t)−RxMEP#B(t)−ΣLoss(t)=300−260−40=0.

It is, therefore, proved that the number of frame losses between MIP#3 and MEP#B is zero, that is, no loss occurs.

Finally, MEP#B changes the reception counter value into “300” that is the transmission counter value of the source MEP#A, and completes the frame loss determination at MEP#B.

(Frame loss measurement at source MEP#A)

When the LMM frame reaches MEP#B, MEP#B transmits the LMR frame toward MEP#A as described in the second exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (8), the following formula is obtained,

Loss(far-end)=TxFCf(t)−RxFCf(t)=300−260=40.

Therefore, it is proved that the number of frame losses of the end-to-end, that is between MEP#A and MEP#B, is 40.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 24, MIP#2, with which the number of losses “10” is associated, is stored in the LMR frame as the frame loss occurrence MIP-ID. Further, the number of losses “30” which is associated with MIP#3 is stored therein. Accordingly, it is identified that 10 frame losses occur between MIP#1 and MIP#2, and 30 frame losses occur between MIP#2 and MIP#3.

### <Example of Operations (4)>

In the example of operations (3), the case in which the LMM frame is transmitted from MEP#A to MEP#B is described, and descriptions on the LMR frame is omitted. In this example of operations, a case in which the LMR frame is transmitted from MEP#B to MEP#A in the second exemplary embodiment are described by using the numerical example.

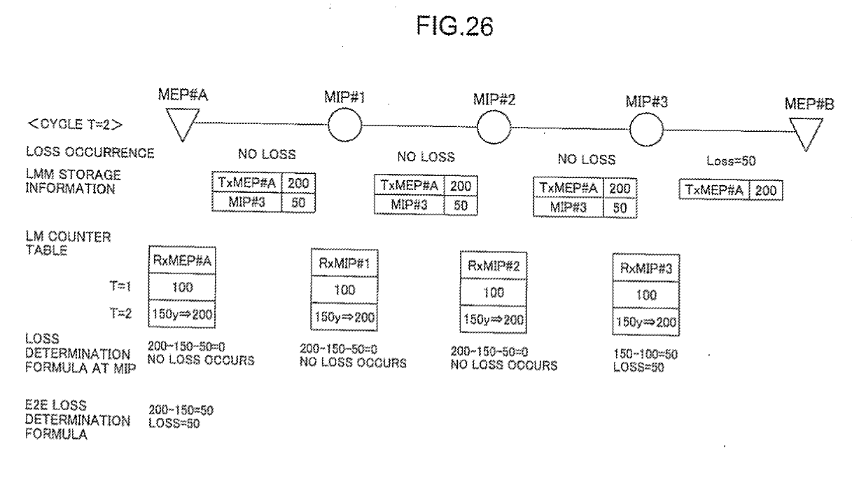

FIG. 26 illustrates information transition which occurs when MEP#B receiving the LMM frame transmits the LMR frame as a reply thereof toward MEP#A and the LMR frame passes through each MEP/MIP. Specifically, calculations of the counter value stored in the LMR frame, the information on the number of losses, the storage information in the LM counter table 32 at each MEP/MIP, and frame loss determination at each MEP/MIP are illustrated.

FIG. 26 shows a condition in the current cycles T=2. Numerical values at the time of executing LM in the cycles T=1, 2 are described in each table. The source MEP#B transmits 100 frames in each cycle. Losses of 50 frames occur between MEP#B and MIP#3 in the cycle T=2. In the cycle T=1, each MEP/MIP stores the same information as the information in the cycle T=1 in FIG. 24. For simplification, operations in the cycle T=2 are described here. The information of only near-end direction (direction from MEP#B to MEP#A) is described.

(Frame Loss Determination at MIP#3)

Details of frame loss determination at MIP#3 in the cycle T=2 are described below.

On receiving the LMR frame from MEP#B, MIP#3 obtains the transmission counter value of MEP#B (TxMEP#B) in the current cycle T=2, that is TxFCb(t)=200, from the storage information in the received LMR frame. At the same time, MIP#3 obtains ΣLoss (t)=0 (the number of losses between MEP#B and the preceding MIP) from the LMR frame.

Next, MIP#3 obtains the reception counter value of MIP#3 in the current cycle T=2, that is RxFCb_mip(t)=150, from the counter table 22.

Next, the number of frame losses between MEP#B and MIP#3 which is calculated by the formula (6) is as follows,

TxMEP#B(t)−RxMIP#3(t)−ΣLoss′(t)=200−150−0=50.

It is proved that the frame loss occurs between MEP#B and MIP#3, and the number of losses is 50.

MIP#3 changes the reception counter value “150” into “200” that is the transmission counter value of the source MEP#B, and completes the frame loss determination at MIP#3.

Finally, MIP#3 stores its own MIP-ID and the number of losses into the LMR frame and transmits the LMR frame to the next apparatus (MIP#2), responding to loss occurrence at the MIP#3.

(Frame Loss Determination at MIP#2)

Details of frame loss determination at MIP#2 in the cycle T=2 are described below.

On receiving the LMR frame from MIP#3, MIP#2 obtains the transmission counter value of MEP#B (TxMEP#B) in the current cycle T=2, that is TxFCb(t)=200, from the storage information in the received LMR frame. At the same time, MIP#2 obtains ΣLoss (t)=50 (the number of losses between MEP#B and the preceding MIP) from the LMR frame.

The value of ΣLoss (t) is 50, because the frame loss in which the number of losses is 50 occurs in the section of MEP#B-MIP#3.

Next, MIP#2 obtains the reception counter value of MIP#2 in the current cycle T=2, that is RxFCb_mip(t)=150, from the counter table 22.

Next, the number of frame losses between MIP#3 and MIP#2 which is calculated by the formula (6) is as follows,

TxMEP#B(t)−RxMIP#2(t)−ΣLoss′(t)=200−150−50=0.

It is proved that the number of frame losses between MIP#3 and MIP#2 is zero, that is, no frame loss occurs.

MIP#2 changes the reception counter value “150” into “200” that is the transmission counter value of the source MEP#B, and completes the frame loss determination at MIP#2.

(Frame Loss Determination at MIP#1)

Details of frame loss determination at MIP#1 in the cycle T=2 are described below.

On receiving the LMR frame from MIP#2, MIP#1 obtains the transmission counter value of MEP#B (TxMEP#B) in the current cycle T=2, that is TxFCb(t)=200, from the storage information in the received LMR frame. At the same time, MIP#1 obtains ΣLoss (t)=50 (the number of losses between MEP#B and the preceding MIP) from the LMR frame.

The value of ΣLoss (t) is 50, because the frame losses in which the number of losses is 50 occur in the section between MEP#B and MIP#3, as described above.

Next, MIP#1 obtains the reception counter value of MIP#1 in the current cycle T=2, that is RxFCb_mip(t)=150, from the counter table 22.

Next, the number of frame losses between MIP#2 and MIP#1 which is calculated by the formula (6) is as follows,

TxMEP#B(t)−RxMIP#1(t)−ΣLoss′(t)=200−150−50=0.

It is proved that the number of frame losses between MIP#2 and MIP#1 is zero, that is, no frame loss occurs.

MIP#1 changes the reception counter value “150” into “200” that is the transmission counter value of the source MEP#B, and completes the frame loss determination at MIP#1.

(Frame loss measurement at source MEP#A)

Details of the frame loss determination at MEP#A in cycle T=2 are described below.

On receiving the LMR frame from MIP#1, MEP#A obtains the transmission counter value of MEP#B (TxMEP#B) in the current cycle T=2, that is TxFCb(t)=200, from the storage information in the received LMR frame. At the same time, MEP#A obtains Σ Loss (t)=50 (the number of losses between MEP#B and the preceding MIP) from the LMR frame.

The value of Σ Loss (t) is 50, because the frame losses in which the number of losses is 50 occur in the section between MEP#B and MIP#3, as described above.

Next, MEP#A obtains the reception counter value of MEP#A in the current cycle T=2, that is RxFCb_mip(t)=150, from the counter table 22.

Next, the number of frame losses between MIP#1 and MEP#A which is calculated by the formula (6) is as follows,

TxMEP#B(t)−RxMEP#A(t)−ΣLoss′(t)=200−150−50=0.

It is proved that the number of frame losses between MIP#1 and MEP#A is zero, that is, no frame loss occurs.

Next, frame loss measurement which is executed when the LMR frame reaches MEP#A is described below.

MEP#A measures the end-to-end frame loss. By using the formula (9), the following formula is obtained,

Loss(near-end)=TxFCb(t)−RxFCb(t)=200−150=50.

Therefore, it is proved that the number of frame losses of the end-to-end, that is, between MEP#B and MEP#A, is 50.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 16, MIP#3 is stored in the LMR frame as the frame loss occurrence MIP-ID, and the number of losses is “50”. Accordingly, it is identified that 50 frame losses occur between MEP#B and MIP#3.

MEP#A changes the reception counter value “150” into “200” that is the transmission counter value of the source MEP#B, and completes the frame loss determination at MEP#A.

### Third Exemplary Embodiment

A third exemplary embodiment of the invention is described in detail by using drawings. In the third exemplary embodiment, a method for calculating the frame loss is disclosed, in which the transmission counter value of the source MEP and a history of the preceding cycle of the reception counter value in the MEP/MIP are not used, just like the second exemplary embodiment.

The third exemplary embodiment differs from the second exemplary embodiment in that MEP/MIP which detects frame loss occurrence do not directly correct the local counter value of the apparatus itself, but keeps the number of accumulated frame losses in the MEP/MIP itself. In the third exemplary embodiment, when the frame loss is calculated, the number of accumulated frame losses is used to correct the local counter (reception counter) of the MEP/MIP itself.

An entire configuration of a system is similar to those of the first and second exemplary embodiments (FIG. 1). In the third exemplary embodiment, an OAM control unit thereof is changed compared with the communication apparatuses 1 to 5 (FIG. 2) of the first exemplary embodiment and the communication apparatus of the second exemplary embodiment. The OAM control unit is described below. The other elements are the same as those of the first and second exemplary embodiments, and detailed descriptions thereof are omitted.

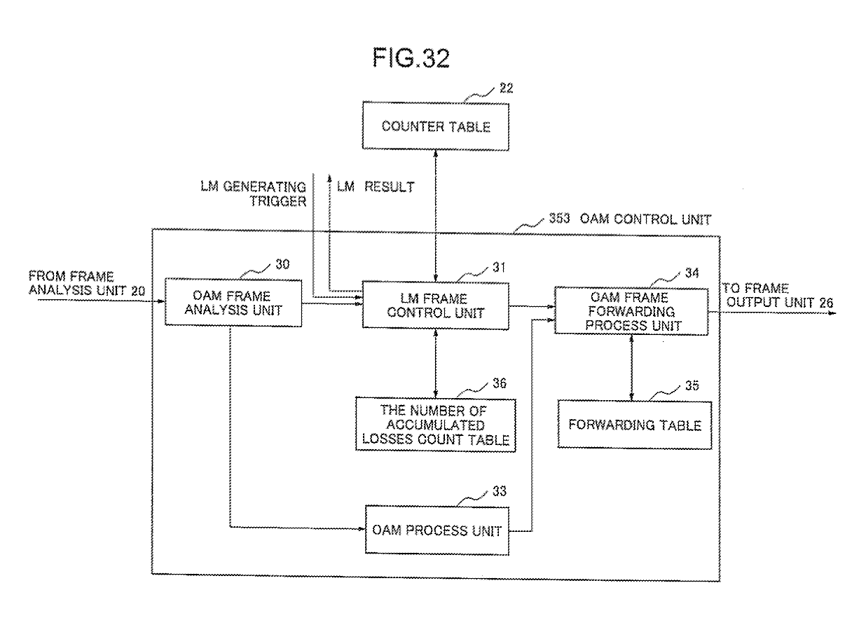

FIG. 32 is a block diagram illustrating a configuration of the OAM control unit 353 of the third exemplary embodiment. The third exemplary embodiment differs from the first and second exemplary embodiments in that a count table for the number of accumulated losses is arranged. Therefore, operations of the LM frame control unit 31 are different. The operations of the third exemplary embodiment are described below centering on the operations of the LM frame control unit 31.

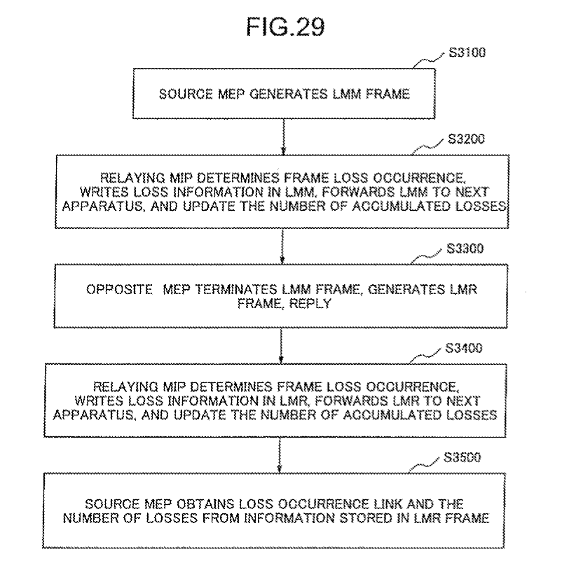

FIG. 29 is a flowchart illustrating entire operations of the third exemplary embodiment. Since step S3100, step S3300 and step S3500 are similar to Step S1100, step S1200 and step S1500 of the first exemplary embodiment (FIG. 5), respectively, detailed descriptions are omitted. Outlines of step S3200 and step S3400 are described below.

In step S3200, relaying MIP#1, MIP#2 and MIP#3 determines whether or not the frame loss occurs, on receiving the LMM frame. If occurrence of the frame loss is determined, information on the number of frame losses is stored in the LMM frame and the LMM frame is forwarded to the next apparatus (MIP#2, MIP#3, MEP#B). Additionally, each M EP/MEP updates the number of accumulated frame losses held by the MEP/MIP itself.

In step S3400, relaying MIP#3, MIP#2 and MIP#1 determines whether or not the frame loss occurs, on receiving the LMR frame. When the frame loss occurs, information on the number of losses is stored in the LMR frame and the LMR frame is forwarded to the next apparatus (MIP#2, MIP#1, MEP#A). After that, each MEP/MIP updates the number of accumulated frame losses held by the MEP/MIP itself.

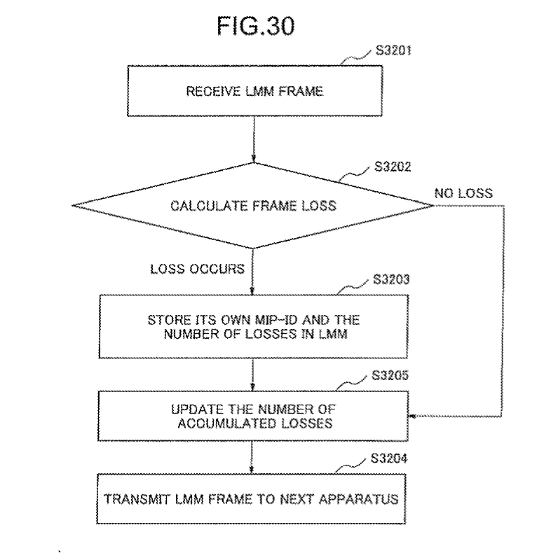

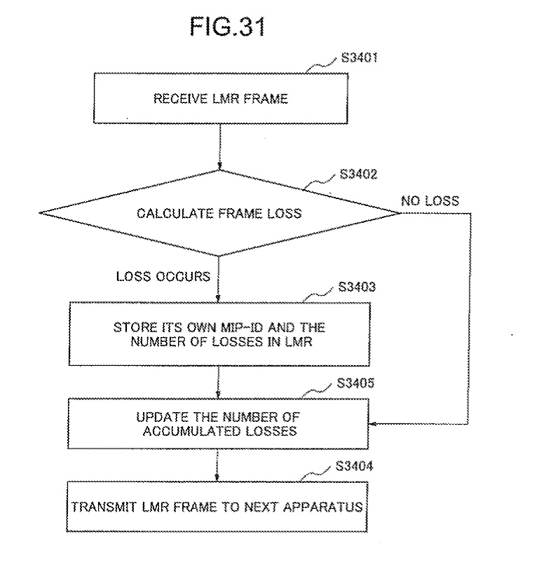

Details of step S3200 and step S3400 are described below by using FIG. 30 and FIG. 31.

FIG. 30 is a flowchart illustrating detailed operations of step S3200 in FIG. 29.

In step S3201, the LM frame control unit 31 receives the LMM frame from the OAM frame analysis unit 30.

Next, the LM frame control unit 31 calculates the frame loss in step S3202. A deriving formula for calculating the frame loss is as follows,

Loss_MIP(far_end)=TxFCf(t)−(RxFCf_mip(t)+Acc_Loss(t))−ΣLoss(t) formula (10).

In the formula (10), Acc_Loss (t) indicates the number of accumulated frame losses in the current cycle T=t.

The LM frame control unit 31 obtains parameters which are necessary for calculation of the formula (10), from the followings,

TxFCf(t): from the received LMM frame,

RxFCf_mip(t): by referring to the counter table 22,

Acc_Loss (t): by referring to an accumulated frame loss table

Σ Loss (t): from the received LMM frame.

In the frame loss calculation in step S3202, step S3203 is executed when the frame loss is detected. In step S3203, the LM frame control unit 31 writes its own MIP-ID and the number of frame losses into the LMM frame, and forwards the LMM frame to the OAM frame forwarding process unit 34.

Next, in step S3205, the LM frame control unit 31 updates the number of accumulated frame losses stored in the accumulated frame loss table by using the following formula (11),

Acc_Loss(t)=Acc_Loss(t−1)+Loss_MIP+ΣLoss(t) formula (11).

In step S3204, the OAM frame forwarding process unit 34 refers to the forwarding table 35 and determines the output port. After that, the OAM frame forwarding process unit 34 forwards the LMM frame to the frame output unit 26. The frame output unit 26 forwards the LMM frame to the next apparatus. In step S3202, step S3205 is directly executed when no frame loss is detected.

Next, detailed operations in step S3400 of FIG. 29 are described. FIG. 31 is a flowchart illustrating detailed operations in step S3400 of FIG. 29.

In step S3401, the LM frame control unit 31 receives the LMR frame from the OAM frame analysis unit 30.

Next, in step S3402, the frame loss calculation is executed. A deriving formula used in the frame loss calculation is the following formula (12) in which formula (10) is converted to the near-end direction,

Loss_MIP(near_end)=TxFCb(t)−(RxFCb_mip(t)+Acc_Loss(t))−ΣLoss′(t) formula (12).

The LM frame control unit 31 obtains parameters which are necessary for calculation of the formula (12), from the followings,

TxFCb(t): from the received LMR frame,

RxFCb_mip(t): from the counter table 22,

Acc_Loss (t): from the accumulated frame loss table,

Loss′ (f): from the received LMR frame like Σ Loss (t).

In the frame loss calculation in step S3402, step S3403 is executed when the frame loss is detected. In step S3403, the LM frame control unit 31 writes its own MIP-ID and the number of frame losses into the LMR frame, and forwards the LMR frame to the OAM frame forwarding process unit 34. In step S3405, the LM frame control unit 31 updates the number of accumulated frame losses stored in the accumulated frame loss table by using the formula (11).

Finally, in step S3404, the OAM frame forwarding process unit 34 refers to the forwarding table 35 and determines the output port. After that, the OAM frame forwarding process unit 34 forwards the LMR frame to the frame output unit 26. The frame output unit 26 forwards the LMR frame to the next apparatus. In step S3402, step S3404 is directly executed when no frame loss is detected.

In the third exemplary embodiment, in step S3200 and step S3400, frame loss occurrence can be detected from the transmission counter value of the source MEP and the reception counter value of MIP of the apparatus, and MIP-ID information and the information on the number of losses are transmitted when a loss occurs. Since the information is not written when no frame loss occurs, a frame size can be decreased and band efficiency can be enhanced.

Additionally, in step S3200 and step S3400, MEP/MIP, where a frame loss occurs, calculates and transmits the number of frame losses. Therefore, in step S3500, if referring to the storage information in the LMR frame and calculating the frame loss between the last MIP where the LMR passes through and the source MEP, the source MEP can obtain the frame loss occurrence MIP and the information on the number of losses. Therefore, amount of calculations at each MEP can be reduced.

The third exemplary embodiment differs from the first and second exemplary embodiments in that the frame loss occurring MEP/MIP corrects the number of accumulated frame losses of the apparatus. It, therefore, becomes possible to calculate the frame loss by using only the counter value in the current cycle, in each MEP/MIP. Accordingly, it is not necessary to hold the history information in the preceding cycle of the transmission counter value of the source MEP/the reception counter value of MIP of the apparatus.

### <Example of Operations (5)>

Detailed operations of the third exemplary embodiment are described below by using specific numerical examples.

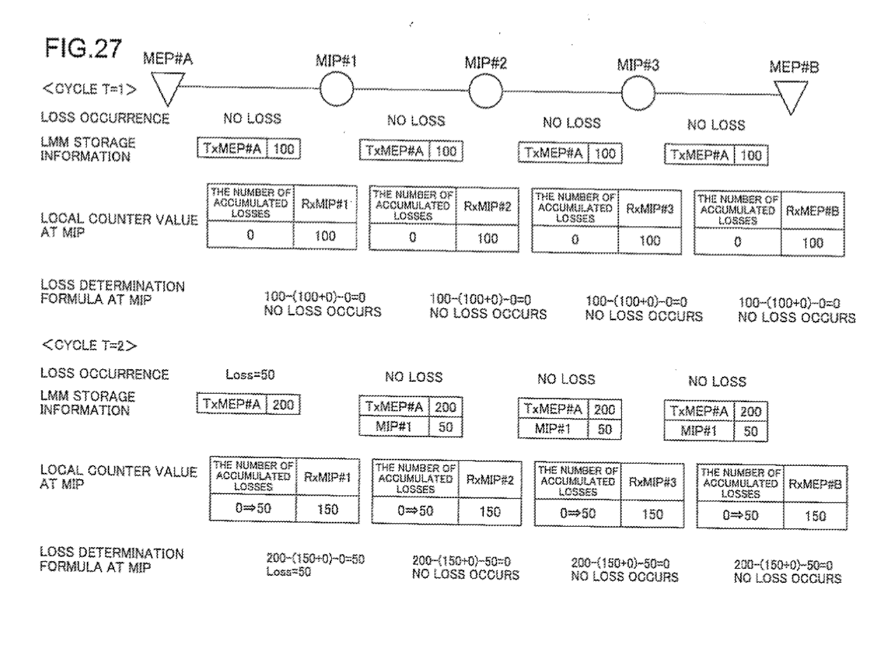

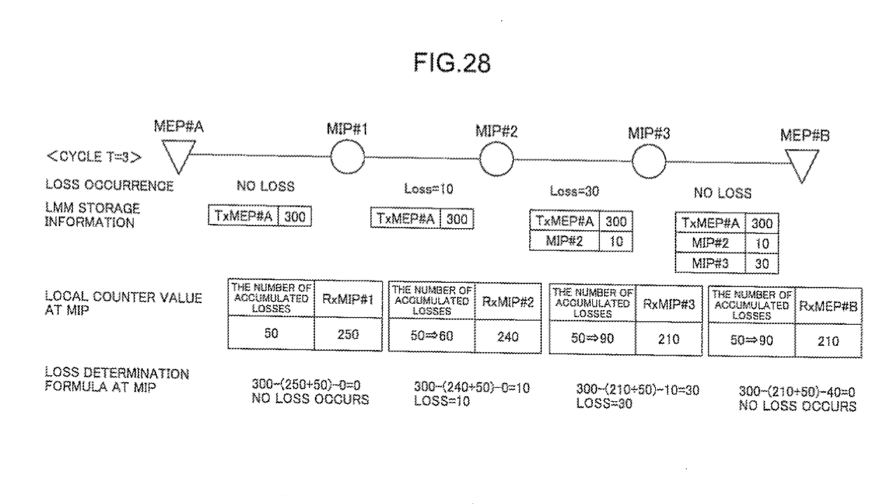

FIG. 27 and FIG. 28 illustrate calculations of the counter value stored in the LMM frame at the time of executing LM on the network in FIG. 1, the information on the number of losses, the storage information in the LM counter table 32 at each MEP/MIP, and frame loss determination at each MEP/MIP. In FIG. 27 and FIG. 28, an example of the far-end direction is only described, for simplification. Additionally, it is supposed that a new frame loss does not occur in the near-end direction.

FIG. 27 shows numerical examples in the cycles T=1, 2. FIG. 28 shows numeric values of T=3, at the time of executing LM, as an example in which frame losses occur in a plurality of sections.

The source MEP#A transmits 100 frames in each cycle. Losses of 50 frames occur between MEP#A and MIP#1 in the cycle T=2. Losses of 10 frames occur between MIP#1 and MIP#2 and losses of 30 frames occur between MIP#2 and MIP#3, in the cycle T=3.

The storage information in the LMM frame in each cycle and transition of conditions in the LM counter table and frame loss measurement at each MEP/MIP is described in detail, by using numerical examples.

### <Cycle T=1>

(Frame Loss Determination at MIP#1)

Details of frame loss determination at MIP#1 in the cycle T=1 are described below. On receiving the LMM frame from MEP#1, MIP#1 obtains the transmission counter value of MEP#A (TxMEP#A) in the current cycle T=1, that is TxFCf(t)=100, from the storage information in the received LMM frame. At the same time, MIP#1 obtains ΣLoss (t)=0 (the number of losses between MEP#A and the preceding MIP) from the LMM frame.

Next, MIP#1 obtains the reception counter value RxFCf_mip(t)=100 in the current cycle T=1 from the counter table 22.

Next, the number of frame losses between MEP#A and MIP#1 which is calculated by the formula (10) is as follows,

TxMEP#A(t)−(RxMIP#1(t)+Acc_Loss(t))−ΣLoss(t)=100−(100+0)−0=0.

It is proved that the number of frame losses between MEP#A and MIP#1 is zero, that is, no loss occurs.

Finally, MIP#1 updates the number of accumulated frame losses. The updated number of accumulated frame losses is as follows, by using formula (11),

Acc_Loss(t)=Acc_Loss(t−1)+Loss_MIP+ΣLoss(t)=0+0+0=0.

Therefore, the value is not changed.

(Frame loss determination at MIP#2, MIP#3 and MEP#B)

Conditions in frame loss determination at MIP#2, MIP#3 and MEP#B are similar to that of MIP#1, since no frame loss occurs in any section. Therefore, descriptions on the frame loss determination at MIP#2, MIP#3 and MEP#B are omitted.

(Frame Loss Determination at Source MEP#A)

When the LMM frame reaches MEP#B, MEP#B transmits the LMR frame toward MEP#A as described in the second exemplary embodiment. Descriptions on performances which are executed when the LMR frame reaches each MEP/MIP are omitted, and frame loss measurement which is executed when the LMR frame reaches MEP#A is described below.

MEP#A measures the end-to-end frame loss. By using the formula (8), the following formula is obtained,

Loss(far-end)=TxFCf(t)−RxFCgt)=100−100=0.

Next, the number of frame losses is measured in each section. Since the frame loss occurrence MIP-ID is not written in the LMR frame received by MEP#A (or since no loss occurs over the end-to-end), it is determined that no loss occurs in each section.

### <Cycle T=2>

A numerical example of frame loss determination at each MEP/MIP in the cycle T=2 is described. In the cycle T=2, the frame loss occurs in the section of MEP#A-MIP#1, and the number of the losses is 50.

### (Frame Loss Determination at MIP#1)

Details of frame loss determination at MIP#1 in the cycle T=2 are described below.

On receiving the LMM frame from MEP#A, MIP#1 obtains the transmission counter value of MEP#A (TxMEP#A) in the current cycle T=2, that is TxFCf(t)=200, from the storage information in the received LMM frame. At the same time, MIP#1 obtains ΣLoss (t)=0 (the number of losses between MEP#A and the preceding MIP) from the LMM frame.

Next, MIP#1 obtains the reception counter value of MIP#1 (RxMIP#1), that is RxFCf mip(t)=150, in the current cycle T=2 from the counter table 22.

Next, the number of frame losses between MEP#A and MIP#1 which is calculated by the formula (10) is as follows,

TxMEP#A(t)−(RxMIP#1(t)+Acc_Loss(t))−ΣLoss(t)=200−(150+0)−0=50.

It is proved that the frame loss occurs between MEP#A and MIP#1 and the number of losses is 50.

MIP#1 updates the number of accumulated frame losses. The number of accumulated frame losses after the update is as follows, by using formula (11),

Acc_Loss(t)=Acc_Loss(t−1)+Loss_MIP+ΣLoss(t)=0+50+0=50.

Finally, MIP#1 stores its own MIP-ID and the number of losses into the LMM frame and transmits the LMM frame to the next apparatus (MIP#2), responding to loss occurrence at the MIP#1.

### (Frame Loss Determination at MIP#2)

Details of frame loss determination at MIP#2 in the cycle T=2 are described below.

On receiving the LMM frame from MIP#1, MIP#2 obtains the transmission counter value of MEP#A (TxMEP#A) in the current cycle T=2, that is TxFCf(t)=200, from the storage information in the received LMM frame. At the same time, MIP#2 obtains Σ Loss (t)=50 (the number of losses between MEP#A and the preceding MIP) from the LMM frame.

Next, MIP#2 obtains the reception counter value of MIP#2, that is RxFCf_mip(t)=150, in the current cycle T=2 from the counter table 22.

Next, the number of frame losses between MIP#1 and MIP#2 which is calculated by the formula (10) is as follows,

TxMEP#A(t)−(RxMIP#1(t)+Acc_Loss(t))−ΣLoss(t)=200−(150+0)−50=0.

It is proved that the number of frame losses between MIP#1 and MIP#2 is zero, and no frame loss occurs in the section.

MIP#2 updates the number of accumulated frame losses. The number of accumulated frame losses after the update is as follows, by using formula (11),

Acc_Loss(t)=Acc_Loss(t−1)+Loss_MIP+ΣLoss(t)=0+0+50=50.

(Frame Loss Determination at MIP#3 and MEP#B)

Conditions in frame loss determination at MIP#3 and MEP#B are similar to that of MIP#2, since no frame loss occurs in any sections related to MIP#3 and MEP#B. Therefore, descriptions on the frame loss determination at MIP#3 and MEP#B are omitted.

(Frame loss measurement at source MEP#A)

When the LMM frame reaches MEP#B, MEP#B transmits the LMR frame toward MEP#A as described in the third exemplary embodiment. Descriptions on performances which are executed when the LMR frame reaches each MEP/MIP are omitted, and frame loss measurement which is executed when the LMR frame reaches MEP#A is described below. MEP#A measures the end-to-end frame loss. By using the formula (8), the following formula is obtained,

Loss(far-end)=TxFCf(t)−RxFCf(t)=200−150=50.

Therefore, it is proved that the number of frame losses of the end-to-end, that is, between MEP#A and MEP#B, is 50.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 24, MIP#1 is stored in the LMR frame as the frame loss occurrence MIP-ID, and the number of losses is 50. Accordingly, it is identified that 50 frame losses occur between MEP#A and MIP#1.

### <Cycle T=3>

A numerical example of the frame loss determination at each MEP/MIP in cycle T=3 is described by referring to FIG. 28. In the cycle T=3, the frame losses occur in the section between MIP#1 and MIP#2, and the section between MIP#2 and MIP#3, and the number of the losses in the sections are 10, and 30, respectively.

(Frame Loss Determination at MIP#1)

Details of frame loss determination at MIP#1 in the cycle T=3 are described below. On receiving the LMM frame from MEP#1, MIP#1 obtains the transmission counter value of MEP#A (TxMEP#A) in the current cycle T=3, that is TxFCf(t)=300, from the storage information in the received LMM frame. At the same time, MIP#1 obtains Loss (t)=0 (the number of losses between MEP#A and the preceding MIP) from the LMM frame.

Next, MIP#1 obtains the reception counter value RxFCf_mip(t)=300 in the current cycle T=3 from the counter table 22.

Next, the number of frame losses between MEP#A and MIP#1 which is calculated by the formula (10) is as follows,

TxMEP#A(t)−(RxMIP#1(t)+Acc_Loss(t))−ΣLoss(t)=300−(250+50)−0=0.

It is proved that the frame loss between MEP#A and MIP#1 is zero, that is, no frame loss occurs.

Finally, MIP#1 updates the number of accumulated frame losses. The number of accumulated frame losses after the update is as follows, by using formula (11),

Acc_Loss(t)=Acc_Loss(t−1)+Loss_MIP+ΣLoss(t)=50+0+0=50.

Therefore, the number of accumulated frame losses is not changed.

(Frame loss determination at MIP#2)

Details of frame loss determination at MIP#2 in the cycle T=3 are described below.

On receiving the LMM frame from MIP#1, MIP#2 obtains the transmission counter value of MEP#A (TxMEP#A) in the current cycle T=3, that is TxFCf(t)=300, from the storage information in the received LMM frame. At the same time, MIP#2 obtains Σ Loss (t)=0 (the number of losses between MEP#A and the preceding MIP#1) from the LMM frame.

Next, MIP#2 obtains the reception counter value of MIP#2, that is RxFCf_mip(t)=240, in the current cycle T=3 from the counter table 22.

Next, the number of frame losses between MEP#A and MIP#1 which is calculated by the formula (10) is as follows,

TxMEP#A(t)−(RxMIP#1(t)+Acc_Loss(t))−ΣLoss(t)=300−(240+50)−0=10.

It is proved that the frame loss occurs between MIP#1 and MIP#2, and the number of the losses is 10.

Next, MIP#2 updates the number of accumulated frame losses. The number of accumulated frame losses after the update is as follows, by using formula (11),

Acc_Loss(t)=Acc_Loss(t−1)+Loss_MIP+ΣLoss(t)=50+10+0=60.

Finally, MIP#2 stores its own MIP-ID and the number of losses in the LMM frame, and transmits the LMM frame to the next apparatus (MIP#3), responding to loss occurrence at the MIP#2.

(Frame Loss Determination at MIP#3)

Details of frame loss determination at MIP#3 in the cycle T=3 are described below.

On receiving the LMM frame from MIP#2, MIP#3 obtains the transmission counter value of MEP#A (TxMEP#A) in the current cycle T=3, that is TxFCf(t)=300, from the storage information in the received LMM frame. At the same time, MIP#3 obtains ΣLoss (t)=10 (the total number of losses between MEP#A and the preceding MIP) from the LMM frame.

The value of ΣLoss (t) is 10, because the frame losses in which the number of losses is 10 occur between MIP#1 and MIP#2, and MIP#2 stores the number of losses in the LMM frame.

Next, MIP#3 obtains the reception counter value of MIP#3, that is RxFCf_mip(t)=260, in the current cycle T=3 from the counter table 22.

Next, the number of frame losses between MIP#2 and MIP#3 which is calculated by the formula (10) is as follows,

TxMEP#A(t)−(RxMIP#1(t)+Acc_Loss(t))−ΣLoss(t)=300−(210+50)−10=30.

It is proved that the frame loss occurs between MIP#2 and MIP#3, and the number of the losses is 30.

Next, MIP#3 updates the number of accumulated frame losses. The number of accumulated frame losses after the update is as follows, by using formula (II),

Acc_Loss(t)=Acc_Loss(t−1)+Loss_MIP+Loss(t)=50+30+10=90.

Finally, MIP#3 stores its own MIP-ID and the number of losses in the LMM frame, and transmits the LMM frame to the next apparatus (MEP#B), responding to loss occurrence at the MIP#3.

(Frame Loss Determination at MEP#B)

Details of frame loss determination at MEP#B in the cycle T=3 are described below.

On receiving the LMM frame from MIP#3, MEP#B obtains the transmission counter value of MEP#A (TxMEP#A) in the current cycle T=3, that is TxFCf(t)=300, from the storage information in the received LMM frame. At the same time, MEP#B obtains ΣLoss (t)=40 (the number of losses between MEP#A and the preceding MIP) from the LMM frame.

The value of Σ Loss (t) is 40 here, because the frame losses in which the number of losses is 10 occur in the section between MIP#1 and MIP#2, the frame losses in which the number of losses is 30 occur in the section between MIP#2 and MIP#3, and the total number of losses is 40.

MEP#B obtains the reception counter value of MEP#B in the current cycle T=3, that is RxFCf_mip(t)=260, from the counter table 22.

Next, the number of frame losses between MIP#3 and MEP#B which is calculated by the formula (10) is as follows,

TxMEP#A(t)−(RxMIP#1(t)+Acc_Loss(t))−ΣLoss(t)=300−(210+50)−40=0.

It is, therefore, proved that the number of frame losses between MIP#3 and MEP#B is zero, that is, no loss occurs.

Finally, MEP#B updates the number of accumulated frame losses. The number of accumulated frame losses after the update is as follows, by using formula (11),

Acc_Loss(t)=Acc_Loss(t−1)+Loss_MIP+ΣLoss(t)=50+0+40=90.

(Frame loss measurement at source MEP#A)

When the LMM frame reaches MEP#B, MEP#B transmits the LMR frame toward MEP#A as described in the third exemplary embodiment. Descriptions on performances which are executed when the LMR frame reaches each MEP/MIP are omitted, and the frame loss measurement which is executed when the LMR frame reaches MEP#A is described below.

MEP#A measures the end-to-end frame loss. By using the formula (8), the following formula is obtained,

Loss(far-end)=TxFCf(t)−RxFCf(t)=300−260=40.

Therefore, it is proved that the number of frame losses of the end-to-end, that is, between MEP#A and MEP#B, is 40.

Next, the number of frame losses is measured in each section. The number of frame losses in each section is obtained by referring to the LMR frame received by MEP#A. Since the LMR frame includes MIP-ID where the loss occurs and the number of losses associated with the MIP-ID, it is only necessary to refer to that. Specifically, as shown in FIG. 29, MIP#2, with which the number of losses “10” is associated, is stored in the LMR frame as the frame loss occurrence MIP-ID. Further, the number of losses “30” which is associated with MIP#3 is stored therein. Accordingly, it is identified that 10 frame losses occur between MIP#1 and MIP#2, and 30 frame losses occur between MIP#2 and MIP#3.

### Fourth Exemplary Embodiment

### (Configuration)

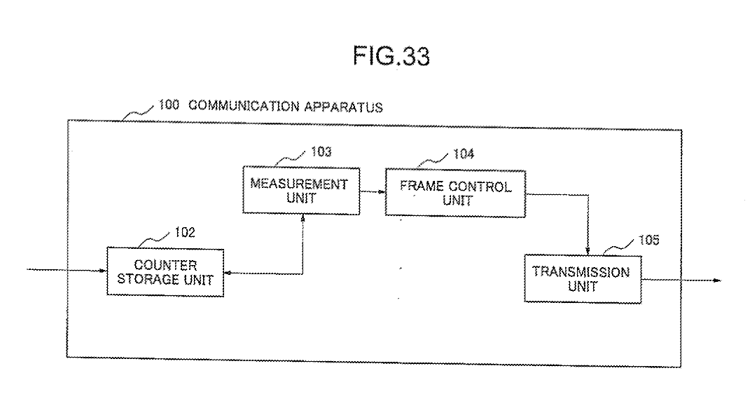

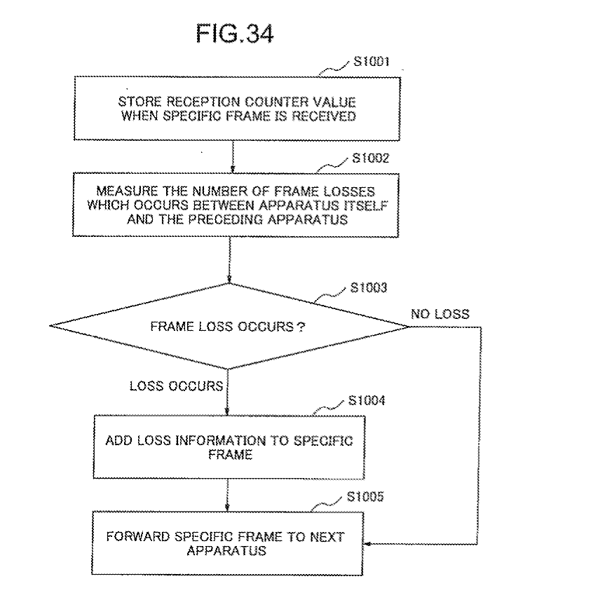

A fourth exemplary embodiment of the invention is described in detail using FIG. 33 and FIG. 34.

FIG. 33 illustrates a configuration of a communication apparatus 100 of the invention. The communication apparatus 100 of the fourth exemplary embodiment includes a counter storage unit 102, a measurement unit 103, a frame control unit 104 and transmission unit 105.

The counter storage unit 102 stores a reception counter value of the communication apparatus 100 when communication apparatuses 1 to 5 receive a specific frame (FIG. 34: step S1001).

The measurement unit 103 measures the number of frame losses which occur between the communication apparatus and the preceding communication apparatus thereof on the basis of the reception counter value of the communication apparatus stored in the counter storage unit 102, a transmission counter value of a source communication apparatus of the specific frame included in the received specific frame, and the total number of frame losses between the source communication apparatus of the specific frame and the preceding apparatus of the communication apparatus.

When the frame loss occurs in the communication apparatus, the frame control unit 104 adds, to the received specific frame, loss information associating the number of frame losses which occur between the communication apparatus and the preceding communication apparatus thereof with an identifier of the communication apparatus (FIG. 34: step S1003 and step S1004).

The transmission unit 105 transmits the specific frame toward the next communication apparatus (FIG. 34: step S1005).

In step S1003, when it is determined that no frame loss occurs in the communication apparatus, addition of the loss information to the specific frame in step S1004 is not performed, but step S1005 is directly performed.

### (Effect)

In the exemplary embodiment, when the frame loss occurs, the loss information, which associates the number of frame losses with the identifier of the communication apparatus, is transmitted. Since the loss information is not added to the frame when no frame loss occurs, a frame size can be decreased and band efficiency can be enhanced.

### Other Exemplary Embodiments

### (Far-End/Near-End Determining Method)

In each of the exemplary embodiments 1 to 3 above described, MEP/MIP which detects frame loss occurrence writes MIP-ID and the number of frame losses in the LM frame. After that, the source MEP which receives the LMR frame determines the loss occurrence section on the basis of the MIP-ID and the number of frame losses stored in the LMR frame. Then, it is necessary to determine whether the frame loss occurs in the far-end direction or in the near-end direction. The determining method is exemplified below, but not limited to the followings.

### (Identifying Method in the LM Frame)

(1) A field of the far-end direction and a field of near-end direction are defined in the LM frame.

(2) The opposite MEP#B writes ID and the number of losses, regardless of presence/absence of frame loss detection. If MIP-ID and the number of losses are written before the opposite MEP#B, it is identified to be the far-end direction. If MIP-ID and the number of losses are written after the opposite MEP#B, it is identified to be the near-end direction.

(3) A bit identifying far-end direction/near-end direction is added to MIP-ID. For example, if one identifying bit is added to the highest rank of MIP-ID, the direction can be identified.

(Identifying Method in the Communication Apparatus)

The reception counter value, the transmission counter value (the exemplary embodiments 1 to 4), the history of the reception counter value and the transmission counter value (the exemplary embodiment 1), the number of accumulated frame losses (the exemplary embodiment 3), stored in the count table or the LM count table, are stored in separate entries or in separate tables in each of the far-end direction and the near-end direction.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### (Supplementary Note 1)

A communication apparatus, comprising:

a counter storage unit storing a reception counter value of the apparatus when a specific frame is received;

a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received;

a transmission unit transmitting the specific frame; and

a frame control unit adding, to the specific frame, loss information associating the number of frame losses occurring between the apparatus and the preceding apparatus with an identifier of the apparatus and forwarding the specific frame to the transmission unit, when the frame loss occurs, and forwarding the specific frame to the transmission unit without adding the loss information to the specific frame, when no frame loss occurs.

### (Supplementary Note 2)

The communication apparatus according to supplementary note 1,

wherein the counter storage unit further stores a history of the reception counter value of the apparatus, the transmission counter value of the source apparatus and a history of the transmission counter value of the source apparatus; and

the measurement unit measures the number of section frame losses occurring between the apparatus and the preceding apparatus thereof on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus of the apparatus.

### (Supplementary Note 3)

The communication apparatus according to supplementary note 1,

wherein the control unit updates the reception counter value of the apparatus stored in the counter storage unit with the transmission counter value of the source apparatus included in the specific frame.

### (Supplementary Note 4)

The communication apparatus according to supplementary note 1,

wherein the counter storage unit further stores the number of accumulated frame losses on a communication path of the specific frame;

the measurement unit measures the number of frame losses occurring between the apparatus and the preceding apparatus thereof on the basis of the reception counter value of the apparatus, the number of accumulated frame losses, the transmission counter value of the source apparatus and the total number of frame losses; and

the control unit updates the number of accumulated frame losses stored in the counter storage unit by adding the number of section frame losses occurring between the apparatus and the preceding apparatus thereof and the total number of frame losses to the number of accumulated frame losses.

### (Supplementary Note 5)

The communication apparatus according to supplementary note 1,

wherein the measurement unit calculates the total number of frame losses by calculating the sum of the number of the section frame losses included in the specific frame.

### (Supplementary Note 6)

The communication apparatus according to supplementary note 1,

wherein the measurement unit calculates the number of frame losses between the source apparatus of the specific frame and the source apparatus making a reply by subtracting the reception counter value of the source apparatus making the reply included in the reply to the specific frame from the transmission counter value.

### (Supplementary Note 7)

The communication apparatus according to supplementary note 1,

wherein the frame control unit determines a section where the frame loss occurs by referring to a communication apparatus, specific identifier stored in the specific frame.

### (Supplementary Note 8)

The communication apparatus according to supplementary note 1,

wherein the transmission unit stores the transmission counter value of the apparatus into the specific frame, when transmitting the specific frame.

### (Supplementary Note 9)

The communication apparatus according to supplementary note 1,

wherein the transmission unit generates a reply to the specific frame, stores the reception counter value of the apparatus in the reply, and transmits the reply, when the specific frame is received.

### (Supplementary Note 10)

A communication system including a plurality of communication apparatus configured to transmit and receive a specific frame, wherein the communication apparatus comprising:

a counter storage unit storing a reception counter value of the apparatus when the specific frame is received;

a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received;

a transmission unit transmitting the specific frame; and

a frame control unit adding, to the specific frame, loss information associating the number of frame losses occurring between the apparatus and the preceding apparatus with an identifier of the apparatus and forwarding the specific frame to the transmission unit, when the frame loss occurs, and forwarding the specific frame to the transmission unit without adding the loss information to the specific frame, when no frame loss occurs.

(Supplementary note 11)

The communication system according to supplementary note 10,

wherein the counter storage unit further stores a history of the reception counter value of the apparatus, the transmission counter value of the source apparatus and a history of the transmission counter value of the source apparatus; and

the measurement unit measures the number of section frame losses occurring between the apparatus and the preceding apparatus thereof on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus of the apparatus.

### (Supplementary Note 12)

The communication system according to supplementary note 10,

wherein the control unit updates the reception counter value of the apparatus stored in the counter storage unit with the transmission counter value of the source apparatus included in the specific frame.

### (Supplementary Note 13)

The communication system according to supplementary note 10,

wherein the counter storage unit further stores the number of accumulated frame losses on a communication path of the specific frame;

the measurement unit measures the number of frame losses occurring between the apparatus and the preceding apparatus thereof on the basis of the reception counter value of the apparatus, the number of accumulated frame losses, the transmission counter value of the source apparatus and the total number of frame losses; and

the control unit updates the number of accumulated frame losses stored in the counter storage unit by adding the number of section frame losses occurring between the apparatus and the preceding apparatus thereof and the total number of frame losses to the number of accumulated frame losses.

### (Supplementary Note 14)

The communication system according to supplementary note 10,

wherein the measurement unit calculates the total number of frame losses by calculating the sum of the number of the section frame losses included in the specific frame.

### (Supplementary Note 15)

The communication system according to supplementary note 10,

wherein a communication apparatus that is a source of the specific frame in the communication apparatuses subtracts a reception counter value of a destination apparatus from the transmission counter value, and counts the number of frame losses between the source apparatus and the destination apparatus.

### (Supplementary Note 16)

The communication system according to supplementary note 10,

wherein a communication apparatus that is a source of the specific frame in the communication apparatuses refers to a communication apparatus specific identifier stored in the specific frame, and determines a section where the frame loss occurs.

### (Supplementary Note 17)

The communication system according to supplementary note 10,

wherein a communication apparatus that is a source of the specific frame in the communication apparatuses stores the transmission counter value of the apparatus into the specific frame, when transmitting the specific frame.

### (Supplementary Note 18)

The communication system according to supplementary note 10,

wherein a communication apparatus that is a destination of the specific frame in the communication apparatuses generates a reply to the specific frame, stores the reception counter value of the apparatus into the reply, and transmits the reply, when receiving the specific frame.

### (Supplementary Note 19)

A communication method, comprising:

storing a reception counter value of the apparatus, when a apparatus receives a specific frame;

measuring the number of frame losses occurring between the apparatus and the preceding apparatus on the basis of the reception counter value of the apparatus, a transmission counter value of a source apparatus of the specific frame included in the specific frame, and the total number of frame losses between the source apparatus and the preceding apparatus of the apparatus, when the apparatus receives the specific frame;

adding, to the specific frame, loss information associating the number of frame losses occurring between the apparatus and the preceding apparatus with an identifier of the apparatus and transmitting the specific frame, when the frame loss occurs; and

transmitting the specific frame without adding the loss information to the specific frame, when no frame loss occurs.

### (Supplementary Note 20)

The communication method according to supplementary note 19, further comprising:

storing a history of the reception counter value of the apparatus, the transmission counter value of the source apparatus and a history of the transmission counter value of the source apparatus, when the apparatus receives the specific frame; and

wherein the measuring the number of frame losses further measures the number of section frame losses occurring between the apparatus and the preceding apparatus on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus.

### (Supplementary Note 21)

The communication method according to supplementary note 19, further comprising:

updating the stored reception counter value of the apparatus with the transmission counter value of the source apparatus included in the specific frame when the apparatus receives the specific frame.

### (Supplementary Note 22)

The communication method according to supplementary note 19, further comprising:

storing the number of accumulated frame losses on a communication path of the specific frame when the apparatus receives the specific frame;

measuring the number of frame losses occurring between the apparatus and the preceding apparatus on the basis of the reception counter value of the apparatus, the number of accumulated frame losses, the transmission counter value of the source apparatus and the total number of frame losses; and

updating the number of accumulated frame losses stored in a counter storage means by adding the number of section frame losses occurring between the apparatus and the preceding apparatus and the total number of frame losses to the number of accumulated frame losses.

### (Supplementary Note 23)

The communication method according to supplementary note 19,

wherein the measuring the frame loss further includes calculating the total number of frame losses by calculating the sum of the number of the section frame losses included in the specific frame.

### (Supplementary Note 24)

The communication method according to supplementary note 19,

wherein the measuring the frame loss further includes subtracting the reception counter value of the source apparatus making a reply included in the reply to the specific frame from the transmission counter value, and calculating the number of frame losses between the source apparatus of the specific frame and the source apparatus making the reply.

### (Supplementary Note 25)

The communication method according to supplementary note 19, further comprising:

determining a section where the frame loss occurs by referring to a communication apparatus specific identifier stored in the specific frame, when the apparatus receives the specific frame.

### (Supplementary Note 26)

The communication method according to supplementary note 19, further comprising:

storing a transmission counter value of the apparatus into the specific frame when the specific frame is transmitted.

### (Supplementary Note 27)

The communication method according to supplementary note 19, further comprising:

generating a reply to the specific frame, storing the reception counter value of the apparatus into the reply and transmitting the reply, when the apparatus receives the specific frame.

### (Supplementary Note 28)

A computer-readable storage medium having a communication program recorded therein for causing a computer comprising:

a counter storage process storing a reception counter value of a apparatus when the apparatus receives a specific frame;

a measurement process measuring the number of frame losses occurring between the apparatus and the preceding apparatus on the basis of the reception counter value of the apparatus, a transmission counter value of a source apparatus of the specific frame included in the specific frame, and the total number of frame losses between the source apparatus and the preceding apparatus of the apparatus, when the apparatus receives the specific frame;

a transmission process transmitting the specific frame; and

a frame control process adding, to the specific frame, loss information associating the number of frame losses occurring between the apparatus and the preceding apparatus with an identifier of the apparatus and performing the transmission step when the frame loss occurs, and performing the transmission step without adding the loss information to the specific frame when no frame loss occurs.

### (Supplementary Note 29)

The computer-readable storage medium according to supplementary note 28,

wherein the counter storage process further storing a history of the reception counter value of the apparatus, the transmission counter value of the source apparatus and a history of the transmission counter value of the source apparatus; and

the measurement process further measuring the number of section frame losses occurring between the apparatus and the preceding apparatus on the basis of the reception counter value of the apparatus, the history of the reception counter value of the apparatus, the transmission counter value of the source apparatus, the history of the transmission counter value of the source apparatus and the total number of frame losses between the source apparatus and the preceding apparatus of the apparatus.

### (Supplementary Note 30)

The computer-readable storage medium according to supplementary note 28,

wherein the control process further updating the reception counter value of the apparatus stored at the counter storage step with the transmission counter value of the source apparatus included in the specific frame.

### (Supplementary Note 31)

The computer-readable storage medium according to supplementary note 28,

wherein the counter storage process further storing the number of accumulated frame losses on a communication path of the specific frame,

the measurement further measuring the number of frame losses occurring between the apparatus and the preceding apparatus on the basis of the reception counter value of the apparatus, the number of accumulated frame losses, the transmission counter value of the source apparatus and the total number of frame losses; and

the control further updating the number of accumulated frame losses stored in counter storage means by adding the number of section frame losses occurring between the apparatus and the preceding apparatus and the total number of frame losses to the number of accumulated frame losses.

### (Supplementary Note 32)

The computer-readable storage medium according to supplementary note 28,

wherein the measurement process further calculating the total number of frame losses by calculating the sum of the number of the section frame losses included in the specific frame.

### (Supplementary Note 33)

The computer-readable storage medium according to supplementary note 28,

wherein the measurement process further subtracting the reception counter value of the source apparatus making a reply included in the reply to the specific frame from the transmission counter value and calculating the number of frame losses between the source apparatus of the specific frame and the source apparatus making the reply.

### (Supplementary Note 34)

The computer-readable storage medium according to supplementary note 28,

wherein the control process further determining a section where the frame loss occurs by referring to a communication apparatus specific identifier stored in the specific frame.

### (Supplementary Note 35)

The computer-readable storage medium according to supplementary note 28,

wherein the transmission process further storing a transmission counter value of the apparatus into the specific frame when the specific frame is transmitted.

### (Supplementary Note 36)

The computer-readable storage medium according to supplementary note 28,

wherein the transmission process further generating a reply to the specific frame, storing the reception counter value of the apparatus into the reply and transmitting the reply, when the specific frame is received.

### (Supplementary Note 37)

A communication apparatus, comprising:

a counter storage means for storing a reception counter value of the apparatus when a specific frame is received;

a measurement means for measuring the number of frame losses occurring between the apparatus and the preceding apparatus on the basis of the reception counter value of the apparatus, a transmission counter value of a source apparatus of the specific frame included in the specific frame, and the total number of frame losses between the source apparatus and the preceding apparatus of the apparatus, when the specific frame is received;

a transmission means for transmitting the specific frame; and

a frame control means for adding, to the specific frame, loss information associating the number of frame losses occurring between the apparatus and the preceding apparatus thereof with an identifier of the apparatus and for forwarding the specific frame to the transmission unit, when the frame loss occurs, and for forwarding the specific frame without adding the loss information to the transmission unit, when no frame loss occurs.

### (Supplementary Note 38)

A communication system, including a plurality of communication apparatus for performing transmission and reception of a specific frame, wherein the communication apparatus comprising:

a counter storage means for storing a reception counter value of the apparatus when the specific frame is received;

a measurement means for measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received;

a transmission means for transmitting the specific frame; and

a frame control means for adding, to the specific frame, loss information associating the number of frame losses occurring between the apparatus and the preceding apparatus with an identifier of the apparatus and for forwarding the specific frame to the transmission unit, when the frame loss occurs, and for forwarding the specific frame to the transmission unit without adding the loss information, when no frame loss occurs.

1. A communication apparatus, comprising:
a counter storage unit storing a reception counter value of the apparatus when a specific frame is received;
a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received;
a transmission unit transmitting the specific frame; and
a frame control unit adding, to the specific frame, loss information associating the number of frame losses occurring between the apparatus and the preceding apparatus with an identifier of the apparatus and forwarding the specific frame to the transmission unit, when the frame loss occurs, and forwarding the specific frame to the transmission unit without adding the loss information to the specific frame, when no frame loss occurs.

2. The communication apparatus according to claim 1,
wherein the counter storage unit further stores a history of the reception counter value of the apparatus, the transmission counter value of the source apparatus and a history of the transmission counter value of the source apparatus; and
the measurement unit measures the number of section frame losses occurring between the apparatus and the preceding apparatus thereof on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus of the apparatus.

3. The communication apparatus according to claim 1,
wherein the control unit updates the reception counter value of the apparatus stored in the counter storage unit with the transmission counter value of the source apparatus included in the specific frame.

4. The communication apparatus according to claim 1,
wherein the counter storage unit further stores the number of accumulated frame losses on a communication path of the specific frame;
the measurement unit measures the number of frame losses occurring between the apparatus and the preceding apparatus thereof on the basis of the reception counter value of the apparatus, the number of accumulated frame losses, the transmission counter value of the source apparatus and the total number of frame losses; and
the control unit updates the number of accumulated frame losses stored in the counter storage unit by adding the number of section frame losses occurring between the apparatus and the preceding apparatus thereof and the total number of frame losses to the number of accumulated frame losses.

5. The communication apparatus according to claim 1,
wherein the measurement unit calculates the total number of frame losses by calculating the sum of the number of the section frame losses included in the specific frame.

6. The communication apparatus according to claim 1,
wherein the measurement unit calculates the number of frame losses between the source apparatus of the specific frame and the source apparatus making a reply by subtracting the reception counter value of the source apparatus making the reply included in the reply to the specific frame from the transmission counter value.

7. The communication apparatus according to claim 1,
wherein the frame control unit determines a section where the frame loss occurs by referring to a communication apparatus specific identifier stored in the specific frame.

8. The communication apparatus according to claim 1,
wherein the transmission unit stores the transmission counter value of the apparatus into the specific frame, when transmitting the specific frame.

9. The communication apparatus according to claim 1,
wherein the transmission unit generates a reply to the specific frame, stores the reception counter value of the apparatus in the reply, and transmits the reply, when the specific frame is received.

10. A communication system including a plurality of communication apparatus configured to transmit and receive a specific frame, wherein the communication apparatus comprising:
a counter storage unit storing a reception counter value of the apparatus when the specific frame is received;
a measurement unit measuring the number of frame losses occurring between the apparatus and the preceding apparatus on the basis of the reception counter value of the apparatus, a transmission counter value of a source apparatus of the specific frame included in the specific frame and the total number of frame losses between the source apparatus and the preceding apparatus of the apparatus, when the specific frame is received;
a transmission unit transmitting the specific frame; and
a frame control unit adding, to the specific frame, loss information associating the number of frame losses occurring between the apparatus and the preceding apparatus with an identifier of the apparatus and to forward the specific frame to the transmission unit, when the frame loss occurs, and forwarding the specific frame to the transmission unit without adding the loss information to the specific frame, when no frame loss occurs.

11. The communication system according to claim 10,
wherein the counter storage unit further stores a history of the reception counter value of the apparatus, the transmission counter value of the source apparatus and a history of the transmission counter value of the source apparatus; and
the measurement unit measures the number of section frame losses occurring between the apparatus and the preceding apparatus thereof on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus of the apparatus.

12. The communication system according to claim 10
wherein the control unit updates the reception counter value of the apparatus stored in the counter storage unit with the transmission counter value of the source apparatus included in the specific frame.

13. The communication system according to claim 10,
wherein the counter storage unit further stores the number of accumulated frame losses on a communication path of the specific frame;
the measurement unit measures the number of frame losses occurring between the apparatus and the preceding apparatus thereof on the basis of the reception counter value of the apparatus, the number of accumulated frame losses, the transmission counter value of the source apparatus and the total number of frame losses; and
the control unit updates the number of accumulated frame losses stored in the counter storage unit by adding the number of section frame losses occurring between the apparatus and the preceding apparatus thereof and the total number of frame losses to the number of accumulated frame losses.

14. The communication system according to claim 10,
wherein the measurement unit calculates the total number of frame losses by calculating the sum of the number of the section frame losses included in the specific frame.

15. The communication system according to claim 10,
wherein a communication apparatus that is a source of the specific frame in the communication apparatuses subtracts a reception counter value of a destination apparatus from the transmission counter value, and counts the number of frame losses between the source apparatus and the destination apparatus.

16. The communication system according to claim 10,
wherein a communication apparatus that is a source of the specific frame in the communication apparatuses refers to a communication apparatus specific identifier stored in the specific frame, and determines a section where the frame loss occurs.

17. The communication system according to claim 10,
wherein a communication apparatus that is a source of the specific frame in the communication apparatuses stores the transmission counter value of the apparatus into the specific frame, when transmitting the specific frame.

18. The communication system according to claim 10,
wherein a communication apparatus that is a destination of the specific frame in the communication apparatuses generates a reply to the specific frame, stores the reception counter value of the apparatus into the reply, and transmits the reply, when receiving the specific frame.

19. A communication method, comprising:
storing a reception counter value of the apparatus, when a apparatus receives a specific frame;
measuring the number of frame losses occurring between the apparatus and the preceding apparatus on the basis of the reception counter value of the apparatus, a transmission counter value of a source apparatus of the specific frame included in the specific frame, and the total number of frame losses between the source apparatus and the preceding apparatus of apparatus, when the apparatus receives the specific frame;
adding, to the specific frame, loss information associating the number of frame losses occurring between the apparatus and the preceding apparatus with an identifier of the apparatus and transmitting the specific frame, when the frame loss occurs; and
transmitting the specific frame without adding the loss information to the specific frame, when no frame loss occurs.

20. The communication method according to claim 19, further comprising:
storing a history of the reception counter value of the apparatus, the transmission counter value of the source apparatus and a history of the transmission counter value of the source apparatus, when the apparatus receives the specific frame; and
wherein the measuring the number of frame losses further measures the number of section frame losses occurring between the apparatus and the preceding apparatus on the basis of the reception counter value of the apparatus, the history of the reception counter value of the apparatus, the transmission counter value of the source apparatus, the history of the transmission counter value of the source apparatus, and the total number of frame losses between the source apparatus and the preceding apparatus.
